(19) United States
(12) Patent Application Publication
(10) Pub. No.: US 2010/0141732 A1
(43) Pub. Date: Jun. 10, 2010

(54) IMAGE RECORDING DEVICE AND METHOD

(75) Inventors: Yoshiharu Sasaki, Shizuoka (JP); Katsuto Sumi, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 11/996,750

(22) PCT Filed: Jul. 20, 2006
(86) PCT No.: PCT/JP2006/314405

§ 371 Date: Jan. 25, 2008

(30) Foreign Application Priority Data
Jul. 25, 2005 (JP) 2005-214660

(51) Int. Cl. B41J 2/47

(52) U.S. Cl. 347/255

(57) ABSTRACT

An object is to repress image degradation due to sensitivity unevenness and a change of sensitivity of a recording medium. Laser light emitted from a plurality of laser light sources are combined, the combined laser light is irradiated to the recording medium including a photosensitive layer and a light-transmitting layer provided over the photosensitive layer, and wavelengths of the laser light emitted from the plurality of laser light sources are determined so as to be distributed within a predetermined wavelength range which is greater than or equal to a resonance minimum wavelength range between a first wavelength wherein light transmittance thereof through the light-transmitting layer is maximized and a second wavelength wherein the light transmittance thereof through the light-transmitting layer is minimized and a different between the first and second wavelengths is minimized.

### TECHNICAL FIELD

The present invention relates to an image recording device and a method, and particularly relates to an image recording device which combines laser light emitted from a plurality of laser light sources and irradiates the combined laser light to a recording medium provided with a light-transmitting layer over an irradiated body so as to record an image on the recording medium, and an image recording method which may be applied to the image recording device.

### BACKGROUND ART

As a drawing method used when a board such as a print wired board (PWB) or a flat panel display (FPD), conventionally, after a mask is produced by once exposing a wiring pattern to be formed on the board on a film, the wiring pattern is drawn on the board using the mask by area exposure (called as an analog drawing method). However, in recent years, a so-called digital drawing method is used such that a wiring pattern is drawn directly on a board by a drawing device based on digital data (drawing raster data) representing the wiring pattern without producing a mask.

As one example of the drawing device which may be applied to such a digital drawing method, PCT National Publication No. JP2002-520644 discloses a directly-writing type printed-circuit board scanning device in which laser light emitted from a single laser light source is modulated by a modulator such as an acoustooptical modulator, and is deflected by a polygon mirror and is scanned on a printed-circuit board, whereby a wiring pattern or the like is directly drawn on the printed-circuit board.

### DISCLOSURE OF THE INVENTION

### Problem to be Solved by the Invention

It is important to densify the wiring pattern to be formed on the board for miniaturization of various devices carrying a print wired board and high definition of images to be displayed on a flat panel display, and accordingly a high definite drawing with minimum resolution of about 15 to 20 μm is required with respect to the drawing of the wiring pattern to the board by a drawing device. For this reason, a resist film, in which a light-transmitting layer as a support body made of PET (polyethylene terephthalate) and having glazing on the surface and a photosensitive layer made of a photosensitive material are laminated, is stuck to the board to be used for drawing the wiring pattern by means of the drawing device so that the light-transmitting layer becomes an upper layer. A wiring pattern is exposed on the board to which the resist film is stuck, whereby the wiring pattern is drawn.

However, when the laser light is irradiated to the board to which the resist film is stuck to draw the wiring pattern, sensitivity with respect to the irradiated laser light is not constant at respective portions of the board, namely, so-called sensitivity unevenness occurs. Width of respective lines in the wiring pattern drawn on the board changes according to the sensitivity with respect to the irradiated laser light at the places where the respective lines are drawn, and as the sensitivity becomes lower, the line width becomes smaller. For this reason, the sensitivity unevenness at the respective portions of the board is not desirable because it causes defective quality such as non-uniform line widths at the respective corresponding portions and defective conductivity of the wiring pattern. When a semiconductor laser such as LD (laser diode) is used as the light source, a wavelength of the laser light emitted from the light source slightly fluctuates according to a temperature change of the light source. However, the sensitivity at the respective portions of the board with respect to the irradiated laser light varies due to only such a slight shift of the wavelength of the laser light.

The present invention is devised in view of the above circumstances, and its object is to obtain an image recording device and an image recording method in which an image can be recorded such that image degradation due to sensitivity unevenness and sensitivity variation of the recording medium is suppressed.

### Means for Solving the Problems

The inventors estimated that the phenomena such as the occurrence of the sensitivity unevenness with respect to the irradiated laser light at the respective portions of the board and the variation of the sensitivity with respect to the irradiated laser light at the respective portions of the board according to the slight shift of the wavelength of the irradiated laser light relates to resonance of the laser light at the light-transmitting layer of the resist film stuck to the board, and conducted an experiment for measuring a variation in light transmission through the light-transmitting layer with respect to the variation in the wavelength of the irradiated light. In this experiment, a PET-made film having a nominal film thickness of 13 μm (actual film thickness is 13.155 μm) (in FIG. 1, described as “product of 13 μm” and a PET-made film having a nominal film thickness of 18 μm (actual film thickness is 18.6 μm) (in FIG. 1, described as “product of 18 μm”) are used as the light-transmitting layer, and light is irradiated to the respective PET films, and the quantity of the transmitted light (light transmittance) of the respective PET films are measured per wavelength by a spectrograph. Both refractive indexes n of the respective PET films are 1.63. The result of the experiment is shown in FIG. 1.

As is clear from FIG. 1, according to the experiment, it is confirmed that the light transmittance vibrationally varies with a substantially constant period with respect to the variation in the wavelength of the irradiated light in both the PET films. In the PET film having the nominal film thickness of 13 μm, the wavelengths wherein the light transmittance thereof is maximum within a wavelength range of 400 to 410 nm are 400.8 nm, 404.6 nm and 408.4 nm, and the wavelengths wherein the light transmittance thereof is minimum are 402.7 mm and 406.5 nm. In the PET film having the nominal film thickness of 18 μm, the wavelengths wherein the light transmission thereof is maximum within the wavelength range of 400 to 410 nm are 401.6 nm, 404.2 nm and 407 nm.

As shown in FIG. 2 as an example, when a spatial beam as a coherent light wave is vertically incident, with respect to a pair of semi-transparent plane mirrors #1 and #2 arranged in parallel, from the semi-transparent plane mirror #1 side, a part of the incident spatial beam is reflected at the semi-transparent plane mirror #1, the residual spatial beam reaches the semi-transparent plane mirror #2, and a part of the residual spatial beam is reflected at the semi-transparent plane mirror #2 so as to reciprocate between the semi-transparent plane mirrors #1 and #2. When an interval L between the semi-transparent plane mirrors #1 and #2 is an integral multiple of a wavelength/2 of the spatial beam, a stationary wave is generated and resonance occurs, and the light transmittance (electric power transmittance) of the semi-transparent plane mirrors #1 and #2 shows a maximum value. A resonator shown in FIG. 2 is called as the Fabry-Perot resonator, and the electric power transmittance T in this resonator is expressed by the following formula (1) wherein refractive index of a medium between the semi-transparent plane mirrors #1 and #2 is denoted by n and the electric power reflectance in each reflection is denoted by R:

$$\begin{matrix}[ Formula 1 ] & \\ T = \frac{1}{1 + \frac{4 R}{{( 1 - R )}^{2}} {sin}^{2} ( {k}_{0} nL )} & ( 1 )\end{matrix}$$

When k₀=2π/λ is assigned to k₀ in the formula (1), the transmittance property showing the variation of the electric power transmittance T (light transmittance) with respect to the variation of the wavelength λ of the spatial beam can be obtained.

When measuring conditions with respect to the PET film having the nominal film thickness of 13 μm (the refractive index n=1.63, the interval L=13.155 μm, the electric power reflectance R=0.05 (reflectance of PET)) and k₀=2π/λ are assigned to the formula (1), and the variation of the electric power transmittance T (light transmittance) within the wavelength range of 400 to 410 nm is calculated, the wavelengths (400.8 nm, 404.6 nm and 408.4 nm) which are the same as the result of the experiment are derived as the wavelengths wherein the light transmittance thereof is maximum, and the wavelengths (402.7 nm and 406.5 nm) which are the same as the result of the experiment are derived as the wavelengths wherein the light transmittance thereof is minimum. Therefore, the vibrational variation of the light transmittance with respect to the variation of the wavelength shown in FIG. 1 can be determined to be caused by resonance of the laser light in the light-transmitting layer of the resist film.

Based on the above results of the experiment, the inventors arrive at a conclusion that the reason why the sensitivity unevenness with respect to the irradiated laser light occurs at the respective portions of the board is that the thickness of the light-transmitting layer of the resist film varies within a manufacturing tolerance, thus the wavelength (resonance wavelength) wherein the light transmittance through the light-transmitting layer is maximum varies at the respective portions of the board and accordingly also the light transmittance through the light-transmitting layer with respect to the laser light having a certain wavelength on the respective portions of the board varies (a variation of the quantity of the light of the irradiated laser light having a certain wavelength which has transmitted through the light-transmitting layer appears as an apparent variation of the sensitivity on the respective portions of the board). Further, the inventors arrive at a conclusion that the reason for the phenomenon that the sensitivity with respect to the irradiated laser light varies at the respective portions of the board according to a slight change in the wavelength of the irradiated laser light is also that the light transmittance through the light-transmitting layer with respect to the irradiated laser light before the change of the wavelength and the light transmittance through the light-transmitting layer with respect to the irradiated laser light after the change of the wavelength differ from each other at the respective portions of the board (it seems that the sensitivity at the respective portions of the board respectively varies since the light transmittance through the light-transmitting layer with respect to the irradiated laser light varies at the respective portions of the board according to the change of the wavelength of the irradiated laser light, and the corresponding quantity of light of the irradiated laser light which has transmitted through the light-transmitting layer respectively varies from that before the change of the wavelength).

Accordingly, an image recording device relating to an invention of a first aspect, wherein laser light emitted from a plurality of laser light sources is combined and the combined laser light is irradiated to a recording medium including a photosensitive layer and a light-transmitting layer provided over the photosensitive layer, so as to record an image on the recording medium, is characterized that the plurality of laser light sources are set such that respective wavelengths of the emitted laser light are distributed within a predetermined wavelength range greater than or equal to a resonance minimum wavelength range corresponding to a range between a first wavelength wherein light transmittance thereof through the light-transmitting layer is maximized and a second wavelength wherein the light transmittance thereof through the light-transmitting layer is minimized and the difference between the first and second wavelengths is minimized.

In the image recording device relating to the invention of the first aspect, when the film thickness of the light-transmitting layer at the respective portions of the recording medium varies within a manufacturing tolerance, the resonance wavelength of the light-transmitting layer corresponding to the respective portions also varies, and the variation of the resonance wavelength appears as a variation of sensitivity at the respective portions of the recording medium. This variation of the sensitivity causes image degradation of the image recorded on the recording medium. Further, when the wavelength of the laser light emitted from the laser light sources varies due to the variation of ambient temperature of the laser light sources, the light transmittance through the light-transmitting layer with respect to the irradiated laser light varies at the respective portions of the recording medium, the variation of the light transmittance appears as the variation of sensitivity at the respective portions of the recording medium, and this variation of sensitivity causes the image degradation of the image recorded on the recording medium.

By contrary, in the invention of the first aspect, the wavelengths of the respective irradiated laser light from the plurality of laser light sources are determined so as to be distributed within the predetermined wavelength range greater than or equal to the resonance minimum wavelength range corresponding to the range between the first wavelength wherein the light transmittance thereof through the light-transmitting layer is maximized and the second wavelength wherein the light transmittance thereof through the light-transmitting layer is minimized and the difference between the first wavelength and second wavelengths is minimized as shown in FIG. 3A. In this manner, the wavelength of the laser light to be irradiated to the recording medium is also distributed within the predetermined wavelength range greater than or equal to the resonance minimum wavelength range, therefore the variation of the quantity of light of the laser light transmitting through the light-transmitting layer at the respective portions of the recording medium and the variation or the change of the quantity of the light transmitting through the light-transmitting layer of the laser light at the respective portions of the recording medium due to the fluctuation in the luminance wavelength of the laser light sources are repressed.

As one example, a case where the number of the laser light sources is two and the wavelengths of the laser light emitted from the individual laser light sources are distributed within the resonance minimum wavelength range as shown as the laser light A and B in FIG. 3B is considered. A wavelength-light transmittance property of the light-transmitting layer at the respective portions of the recording medium shifts, due to the variation of the layer thickness of the light-transmitting layer at the respective portions, along a wavelength axis as shown as “fluctuation due to the variation of the layer thickness of the light-transmitting layer” in FIG. 3B. The wavelengths of the laser light emitted from the laser light sources also shift along the wavelength axis as shown as “fluctuation due to the variation of ambient temperature of the laser light sources” in FIG. 3B, due to the fluctuation of the ambient temperature of the laser light sources. For this reason, the quantity of light transmitting through the light-transmitting layer of the laser light emitted from a single laser light source fluctuates at the respective portions of the recording medium by a difference of the quantity of light corresponding to a difference between the maximum light transmittance (light transmittance of the resonance wavelength (the first wavelength)) and the minimum light transmittance (light transmittance of the second wavelength) in the wavelength-light transmittance property of the light-transmitting layer, due to influences of the variation of the layer thickness of the light-transmitting layer at the respective portions of the recording medium and the fluctuation of ambient temperature of the laser light sources.

By contrary, when the laser light A and B emitted from the two laser light sources are combined and irradiated to the respective portions of the recording medium, the wavelength of the laser light B does not match with the first wavelength and thus the quantity of the light transmitting through the light-transmitting layer of the laser light B becomes smaller than the maximum value at a portion among the respective portions of the recording medium where the wavelength of the laser light A matches with the resonance wavelength (the first wavelength) and the quantity of the light transmitting through the light-transmitting layer of the laser light A indicates the maximum value. Therefore, the quantity of the light transmitting through the light-transmitting layer of the irradiated laser light (laser light obtained by combining the laser light A and B) at such portion becomes smaller than the maximum value. Similarly, the wavelength of the laser light B does not match with the second wavelength and thus the quantity of the light transmitting through the light-transmitting layer of the laser light B becomes larger than the minimum value at a portion among the respective portions of the recording medium where the wavelength of the laser light A matches with the second wavelength and the quantity of the light transmitting through the light-transmitting layer of the laser light A indicates the minimum value. Therefore, the quantity of the light transmitting through the light-transmitting layer of the irradiated laser light (laser light obtained by combining the laser light A and B) at such portion becomes larger than the minimum value. Therefore, a fluctuation width of the quantity of the light transmitting through the light-transmitting layer of the entire irradiated laser light at the respective portions of the recording medium becomes smaller than that in a case where the laser light emitted from a single laser light source is used.

The above example is the case where two laser light sources are used, and even in the case where laser light emitted from three or more laser light sources are combined and irradiated to the respective portions of the recording medium, as long as the wavelength of the laser light emitted from the laser light sources are distributed within the wavelength range greater than or equal to the resonance minimum wavelength range, the fluctuation width of the quantity of the light transmitting through the light-transmitting layer of the irradiated laser light at the respective portions of the recording medium is small. With the fluctuation width becomes small, the variation of sensitivity at the respective portions of the recording medium becomes small, and also the variation of sensitivity at the respective portions of the recording medium in the case where the wavelength of the laser light irradiated from the laser light sources varies due to the change of the ambient temperature of the laser light sources becomes small. Therefore, according to the invention of the first aspect, the image may be recorded so that the image degradation due to the sensitivity unevenness and the variation of sensitivity of the recording medium is repressed.

The predetermined wavelength range of the invention of the first aspect may be, for example, a wavelength range which is two or more times as large as the resonance minimum wavelength range as described in a second aspect, or may be a wavelength range which is four or more times as large as the resonance minimum wavelength range as described in a third aspect. As described above, when the wavelength of the laser light emitted from the plurality of laser light sources are distributed in a wider frequency range (desirably uniformly within the frequency range), the quantity of the light transmitting through the light-transmitting layer of the irradiated laser light at the respective portions of the recording medium can be further uniformized. However, when the sensitivity of the photosensitive layer is not constant with respect to the change of the wavelength of the irradiated laser light, even if the quantity of the light transmitting through the light-transmitting layer of the irradiated laser light at the respective portions of the recording medium is uniform, the sensitivity of the photosensitive layer itself may vary at the respective portions of the recording medium. For this reason, the width of the predetermined wavelength range in the invention of the first aspect is desirably provided with an upper limit in view of the change of sensitivity of the photosensitive layer associated with the variation of the wavelengths of the irradiated laser light.

In the invention of any one of the first to the third aspects, the plurality of laser light sources, for example, as described in a forth aspect, are set such that the wavelengths of the emitted laser light are distributed within the predetermined wavelength range and the respective light transmittances thereof through the light-transmitting layer vary. In this manner, the fluctuation of the quantity of the light transmitting through the light-transmitting layer of the irradiated laser light at the respective portions of the recording medium, and the image degradation due to the sensitivity unevenness and the change of sensitivity of the recording medium can be repressed more accurately.

In the invention of any one of the first to third aspects, for example, as described in a fifth aspect, the image recording device further comprises a surface modulation element wherein emitting directions of light fluxes incident on a modulation surface provided with a plurality of modulation regions are independently controllable in units of respective partial light fluxes incident on the respective modulation regions, wherein laser light fluxes obtained by combining the laser light emitted from the plurality of laser light sources are caused to be incident on the modulation surface of the surface modulation element, and a plurality of partial laser light fluxes emitted in predetermined directions by the surface modulation element in the incident laser light fluxes are guided such that at least a part of the respective partial laser light fluxes emitted from the mutually different modulation regions of the surface modulation element are overlappingly irradiated to respective portions on the recording medium, whereby an image is recorded on the recording medium.

As shown in the present invention, when the wavelengths of the laser light emitted from the plurality of laser light sources are distributed within a certain wavelength range, even if the laser light emitted from the plurality of laser light sources is combined, the distribution wavelength range of the combined laser light (laser light flux) is not always uniform at the respective portions of the laser light flux (partial wavelength ranges of the plurality of partial laser light fluxes forming the entire laser light flux may vary). By contrary, the invention of the fifth aspect includes a surface modulation element wherein the emitting directions of the light fluxes incident on the modulation surface provided with the plurality of modulation regions are independently controllable in units of respective partial light fluxes incident on the respective modulation regions. The laser light fluxes obtained by combining the laser light emitted from the plurality of laser light sources are caused to be incident on the modulation surface of the surface modulation element, and the plurality of partial laser light fluxes emitted in predetermined directions by the surface modulation element in the incident laser light fluxes are irradiated to the recording medium, whereby, in the structure of recording an image on the recording medium, at least a part of the respective partial laser light fluxes emitted from the mutually different modulation regions of the surface modulation element are overlappingly irradiated to the respective portions on the recording medium. Therefore, even if the distribution wavelength ranges of the partial laser light fluxes incident on the respective modulation regions of the surface modulation element vary, at least the partial laser light fluxes with different distribution wavelength ranges are overlappingly irradiated to the respective portions on the recording medium, whereby the light exposure to the respective portions of the recording medium (integrated value of the irradiating quantity of light of the laser light) can be uniformized, and the image quality of recording an image can be improved.

An image recording method of the invention of a sixth aspect for combining and irradiating laser light emitted from a plurality of laser light sources to a recording medium including a photosensitive layer and a light-transmitting layer provided over the photosensitive layer, so as to record an image on the recording medium, comprises determining respective wavelengths of the emitted laser light of the plurality of laser light sources so as to be distributed within a predetermined wavelength range greater than or equal to a resonance minimum wavelength range corresponding to a range between a first wavelength wherein light transmittance thereof through the light-transmitting layer is maximized and a second wavelength wherein the light transmittance thereof through the light-transmitting layer is minimized and the difference between the first and second wavelengths is minimized. For this reason, similarly to the invention of the first aspect, an image can be recorded so that the image degradation due to the sensitivity unevenness and the variation of sensitivity of the recording medium is repressed.

### EFFECT OF THE INVENTION

As described above, the present invention has an excellent effect that when laser light emitted from a plurality of laser light sources are irradiated to a recording medium including a photosensitive layer and a light-transmitting layer provided over the photosensitive layer so as to record an image, the respective wavelengths of the emitted laser light from the plurality of laser light sources are determined so as to be distributed within the predetermined wavelength range greater than or equal to the resonance minimum wavelength range corresponding to a range between the first wavelength wherein the light transmittance thereof through the light-transmitting layer is maximized and the second wavelength wherein the light transmittance thereof through the light-transmitting layer is minimized and the different between the first and second wavelengths is minimized, and thus an image can be recorded so that the image degradation due to the sensitivity unevenness and the variation of sensitivity of the recording medium is repressed.

### BRIEF DESCRIPTION OF THE DRAWINGS

FIG. 1 is a diagram illustrating a wavelength-light transmittance property of a PET film.

FIG. 2 is a schematically constitutional diagram illustrating a Fabry-Perot resonator.

FIG. 3A is a diagram illustrating a resonance minimum wavelength range.

FIG. 3B is a diagram illustrating a wavelength-light transmittance property of a light-transmitting layer, for explaining the effects of the present invention by taking a case where two laser light sources are used as an example.

FIG. 4 is a perspective view illustrating an outline of an image exposing device according to an exemplary embodiment.

FIG. 5A is a schematic diagram illustrating one example of a recording medium.

FIG. 5B is a schematic diagram illustrating one example of the recording medium.

FIG. 5C is a schematic diagram illustrating one example of the recording medium.

FIG. 6 is a perspective view illustrating an outline of a scanner of the image exposing device.

FIG. 7A is a plan view illustrating exposed regions formed on the recording medium.

FIG. 7B is a plan view illustrating an arrangement of exposed areas of respective exposing heads.

FIG. 8 is a perspective view illustrating a schematic constitution of an optical system of the exposing head.

FIG. 9 is a constitutional diagram illustrating the optical system of the recording head in detail.

FIG. 10 is a perspective view illustrating a partially enlarged DMD.

FIG. 11A is a perspective view illustrating an ON state of a micro-mirror of the DMD.

FIG. 11B is a perspective view illustrating an OFF state of the micro-mirror of the DMD.

FIG. 12A is a plan view illustrating an arrangement and scanning lines of an exposing beam when the DMD is not slantingly arranged.

FIG. 12B is a plan view illustrating the arrangement and the scanning lines of the exposing beam when DMD is slantingly arranged.

FIG. 13 is a perspective view illustrating a fiber array light source.

FIG. 14 is a front view illustrating an arrangement of light emitting points in a laser emitting portion of the fiber array light source.

FIG. 15 is a side view illustrating a joined portion of a multimode optical fiber.

FIG. 16 is a plan view illustrating a constitution of a combination laser light source.

FIG. 17 is a plan view illustrating a constitution of a laser module.

FIG. 18 is a side view illustrating the constitution of the laser module.

FIG. 19 is a front view illustrating collimating lenses of the laser module.

FIG. 20 is a block diagram illustrating a schematic constitution of a control system of the image exposing device.

FIG. 21 is an explanatory diagram illustrating an exposed area showing a position of the exposing beam by means of the DMD arranged slantingly.

FIG. 22 is a diagram illustrating a wavelength range of a comparative example in analysis and study conducted by the inventors of the present application.

FIG. 23A is a diagram illustrating the wavelength range of an example 1 in the analysis and study conducted by the inventors of the present application.

FIG. 23B is a diagram illustrating the wavelength range of an example 2 in the analysis and study conducted by the inventors of the present application.

FIG. 23C is a diagram illustrating the wavelength range of an example 3 in the analysis and study conducted by the inventors of the present application.

### BEST ASPECT FOR CARRYING OUT THE INVENTION

One example of an exemplary embodiment of the present invention is described in detail below with reference to the drawings.

[Constitution of Image Exposing Device]

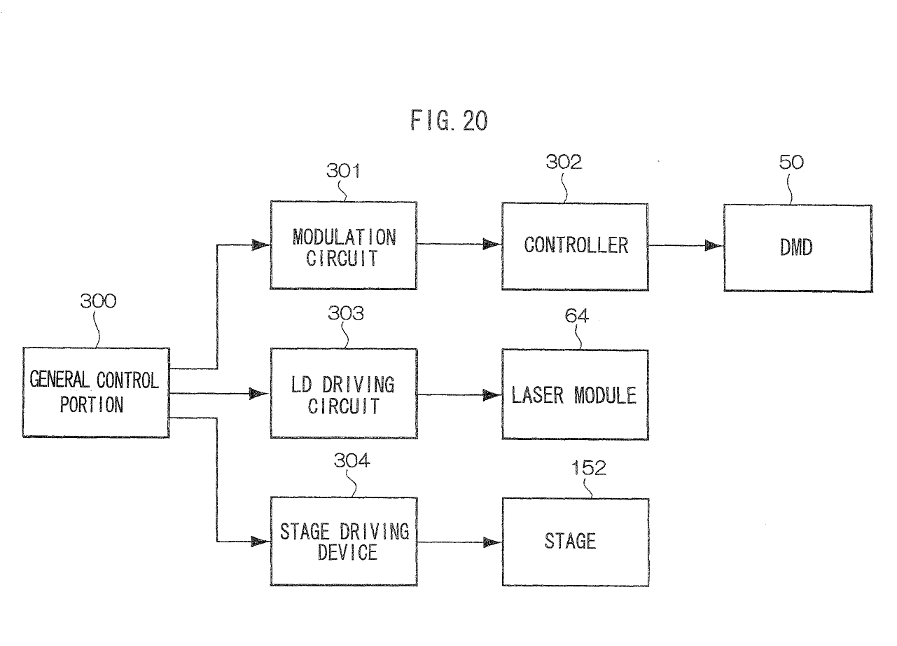

FIG. 4 illustrates an outline of an image exposing device 100 according to the exemplary embodiment. The image exposing device 100 corresponding to an image recording device according to the invention has a flat-plate shaped moving stage 152 which adsorbs and holds a sheet-shaped recording medium 150 to its surface. Two guides 158 which extend along a stage moving direction are arranged on a thick plate-shaped arranging table 156 supported by four leg portions 154, and the moving stage 152 is arranged so that its longitudinal direction is parallel to a longitudinal direction (stage moving direction/sub scanning direction) of the guides 158 and is reciprocably supported by the guides 158. The moving stage 152 is moved along the guides 158 by a stage driving device 304 (see FIG. 20, its details are described later).

A U-shaped gate 160 is provided on a center portion of the arranging table 156 so as to straddle a moving path of the moving stage 152. Both end portions of the gate 160 are respectively fixed at both side surfaces of the arranging table 156. A scanner 162 is disposed at one side above the moving path of the moving stage 152, and a plurality of sensors 164 (for example, 2) which detect a front end and a rear end of the recording medium 150 are disposed at the opposite side, with the gate 160 sandwiched therebetween. The scanner 162 and the sensors 164 are respectively mounted to the side surfaces of the gate 160. The scanner 162 and the sensors 164 are connected to a controller (not shown) which controls them.

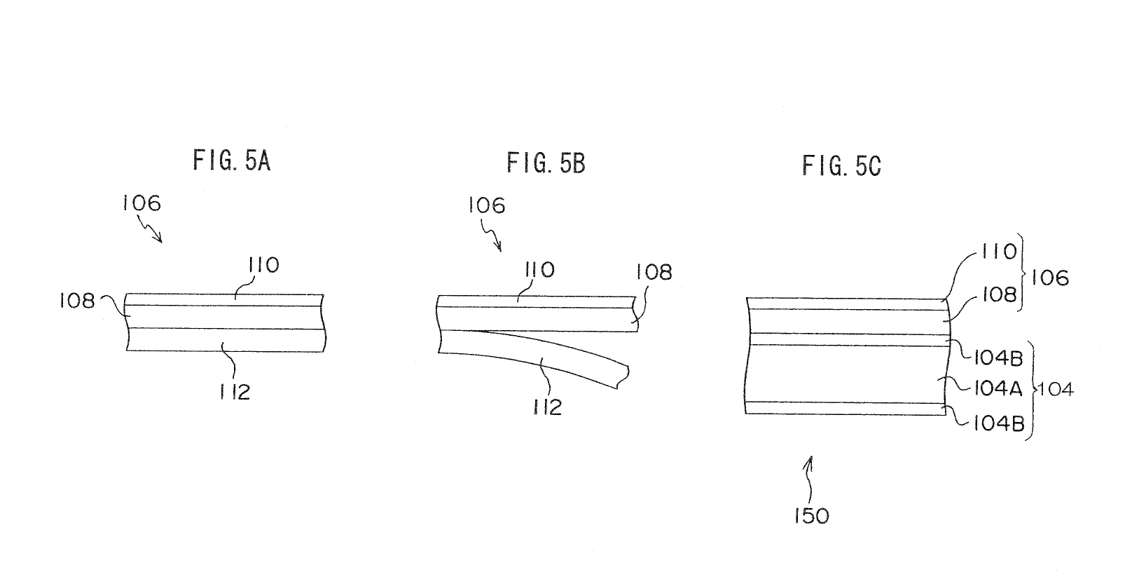

The image exposing device 100 has a function for directly drawing a wiring pattern represented by input image data (printing raster data) on a board (recording medium 150) with a digital drawing method, and is used when a printed circuit board carrying the parts of electric/electronic circuits or a color filter board for a flat panel display is manufactured. For example when the printed circuit board is manufactured, the recording medium 150 shown in FIG. 5C is set on the moving stage 152. The recording medium 150 is manufactured in the following manner.

That is, for example, a board 104, which is obtained by forming a conductive layer 104B made of copper and having a thickness of about 18 μm on front and rear surfaces of a flat plate-shaped base material 104A made of glass epoxy and having a thickness of about 200 μm, is used as a board to be used for manufacturing the printed circuit board. Besides the board 104, a resist film 106 shown in FIG. 5A is prepared. The resist film 106 is constituted so that a photosensitive layer 108 made of a photosensitive material and having a thickness of 15 to 30 μm is sandwiched between a light-transmitting layer 110 made of PET and having nominal thickness of 13 μm (actual thickness is 13.15 μm) or nominal thickness of 18 μm (actual thickness is 18.6 μm) and a back layer 112 made of polyethylene or polypropylene and having a thickness of about 20 to 25 μm. The light-transmitting layer 110 of the resist film 106 serves as a support body, and has glazing on its surface in order to enable the image exposing device 100 to draw the wiring pattern on the recording medium 150 with minimum resolution of 15 to 20 μm and with high definition.

The resist film 106 is wound into a roll shape, and is pulled out of the roll at the time of manufacturing the recording medium 150. After the back layer 112 is peeled as shown in FIG. 5B, the resist film 106 is superimposed on the board 104 so that the light-transmitting layer 110 becomes an upper layer (the photosensitive layer 108 comes in contact with the board 104) as shown in FIG. 5C. The resist film 106 is subject to a laminating process by a laminator (not shown) so as to be stuck to the board 104 with the photosensitive layer 108 closely contacting with the board 104. In this manner, the recording medium 150 is manufactured. The recording medium 150 to be used at the time of manufacturing the color filter board is manufacturing by sticking the resist film 106 to a glass board instead of the board 104.

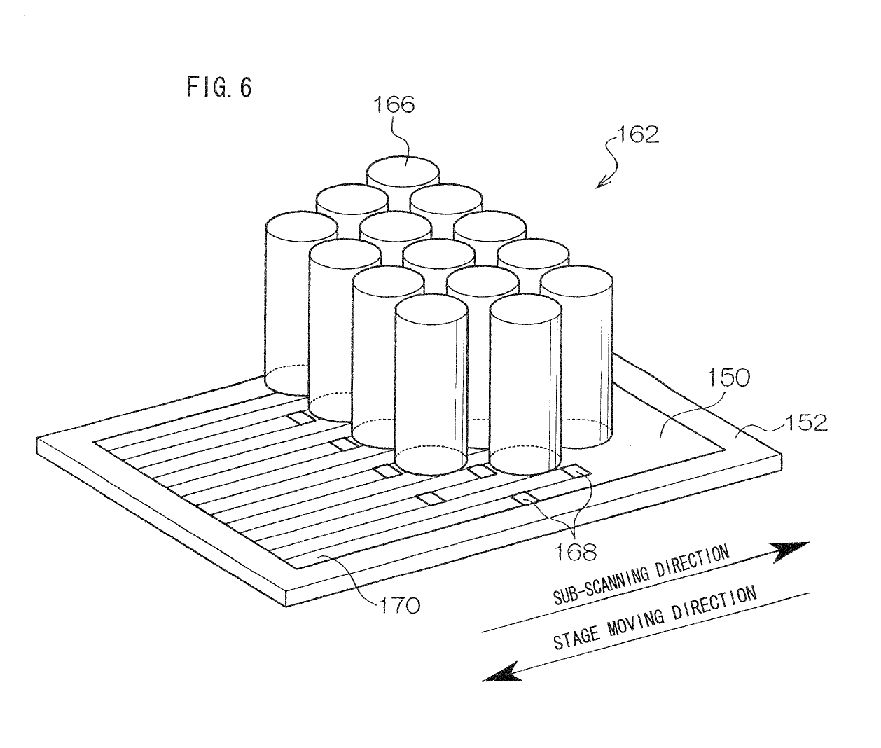

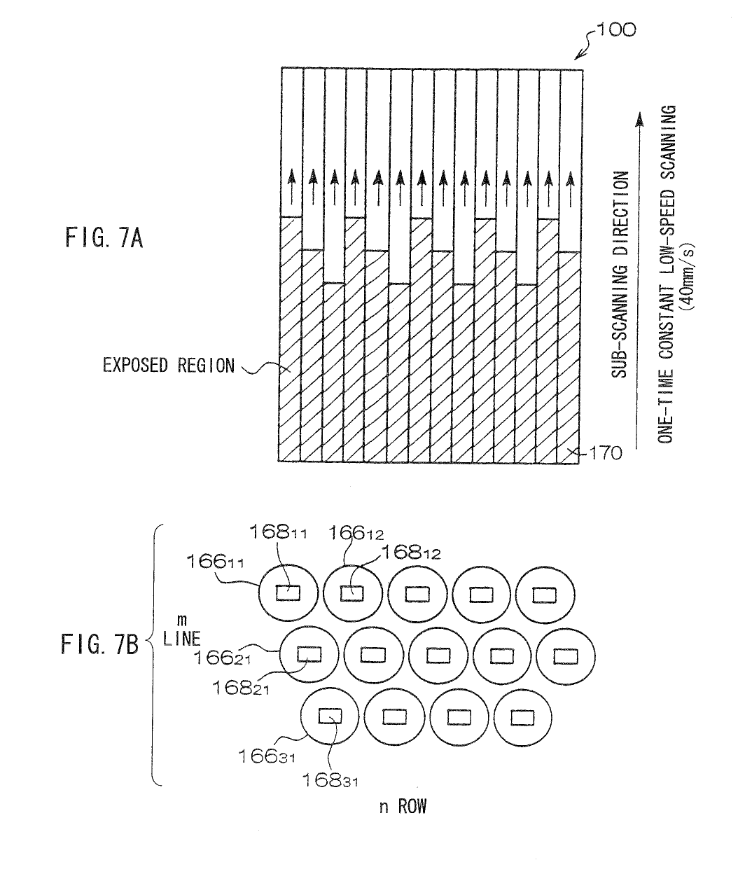

On the other hand, as shown in FIGS. 6 and 7B, the scanner 162 of the image exposing device 100 has a plurality (for example, 14) of exposing heads 166 which are arranged into an approximately matrix pattern having m lines and n rows (for example, 3 lines and 5 rows). FIGS. 6 and 7B illustrate examples where four exposing heads 166 are arranged on the third line according to a relation with the width of the recording medium 150. The exposing head 166 on the m-th line and n-th row is described as the exposing head 166ₘₙ. As shown in FIG. 7B, exposed areas 168 of the exposing heads 166 have a rectangular shape whose short side is in the sub scanning direction. Therefore, according to the movement of the moving stage 152, band-shaped exposed regions 170 (see FIG. 7A) are formed on the recording medium 150 per the respective exposing heads 166. The exposed area of the exposing head 166 on the m-th line and n-th row is described as the exposed area 168ₘₙ.

As shown in FIG. 7B, the exposing heads 166 on the same line are arranged along a main scanning direction (direction perpendicular to the sub scanning direction), and the exposing heads 166 on the same row are arranged to be offset, with respect to adjacent exposing head 166 on the same row, at a predetermined distance (for example, the distance equal to the length of a long side of the exposed area 168) along the main scanning direction, so that the band-shaped exposed regions 170 are arranged along the main scanning direction on the recording medium 150 without a gap (see FIG. 7A). For this reason, the gap between the exposed area 168₁₁ of the exposing head 166₁₁ on the first line and first row and the exposed area 168₁₂ of the exposing head 166₁₂ on the first line and second row is exposed by the exposed area 168₂₁ of the exposing head 166₂₁ on the second line and first row and the exposed area 168₃₁ of the exposing head 166₃₁ on the third line and first row.

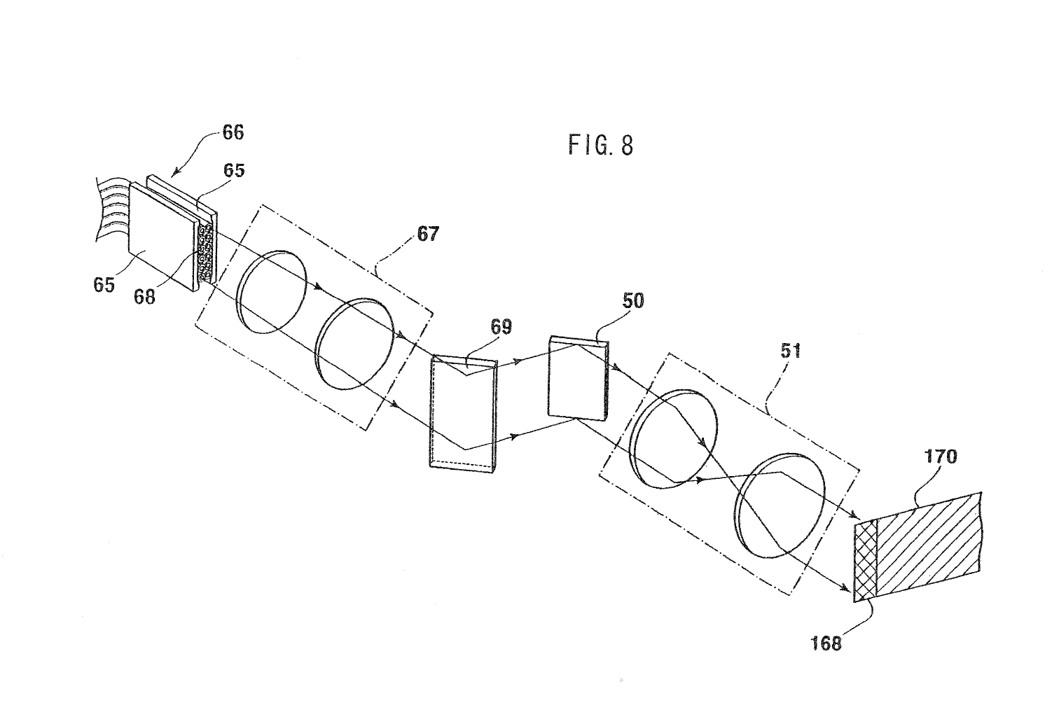

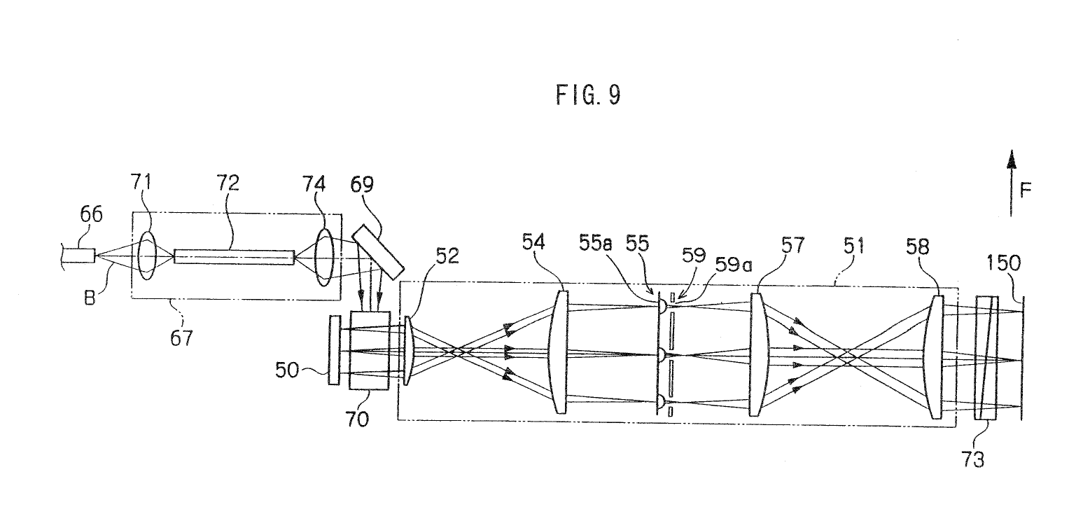

As shown in FIGS. 8 and 9, the exposing heads 166₁₁ to 166ₘₙ respectively have a digital micro-mirror device (DMD) 50 manufactured by Texas Instrument Incorporated U.S. as a spatial light modulation element which modulates incident light beam for each pixel corresponding to image data. The DMD 50 is connected to a controller 302 (see FIG. 20, and its details will be described later) having a data processing portion and a mirror driving control portion. The data processing portion of the controller 302 generates control signals for driving and controlling the respective micro-mirrors in regions to be controlled in the DMD 50 with respect to each exposing heads 166 based on the input image data. The regions to be controlled will be described later. The mirror driving control portion controls angles of reflecting surfaces of the micro-mirrors of the DMD 50 with respect to the respective exposing heads 166 based on the control signals generated by the image data processing portion. The control of the angles of the reflecting surfaces will be described later.

A fiber array light source 66, which has a laser emitting portion whose emitting end portions (light emitting points) of a plurality of optical fibers entirely form a rectangular shape similarly to the exposed area 168 and the long-side direction thereof matches with a direction corresponding to the long-side direction of the exposed area 168, a lens system 67 which corrects and condenses the laser light emitted from the fiber array light source 66 onto the DMD, and a mirror 69 which reflects the laser light transmitting through the lens system 67 towards the DMD 50 are arranged at a light incident side of the DMD 50 in this order.

The lens system 67 schematically shown in FIG. 8 is composed of a condensing lens 71 which condenses the laser light B emitted from the fiber array light source 66, a rod-shaped optical integrator (hereinafter, a rod integrator) 72 which is inserted into an optical path of the laser light B transmitting through the condensing lens 71, and an imaging lens 74 which is arranged at a laser light emitting side of the rod integrator 72 as shown in FIG. 9. The rod integrator 72 is a light-transmitting rod formed into a quadratic prism, for example, and as the laser light B incident into the rod integrator 72 advances while totally reflected in the rod integrator 72, the intensity distribution in beam cross-section is uniformized. A reflection preventing film is formed on an incident end surface and an outgoing end surface of the rod integrator 72 in order to improve the light transmittance. After the laser light emitted from the fiber array light source 66 is converted into light fluxes which are close to parallel light and whose intensity in beam cross-section is uniformized by the condensing lens 71, the rod integrator 72 and the imaging lens 74 of the lens system 67, the light fluxes are reflected by the mirror 69 arranged at the laser light emitting side of the lens system 67, and are irradiated to the DMD 50 via a TIR (total reflection) prism 70. The illustration of the TIR prism 70 is omitted in FIG. 8.

An imaging optical system 51 which images the laser light B reflected by the DMD 50 on the recording medium 150 is arranged at the laser light emitting side of the DMD 50. The imaging optical system 51 schematically shown in FIG. 8 is composed of a first imaging optical system including lens systems 52 and 54, a second imaging optical system including lens systems 57 and 58, and a micro-lens array 55 and an aperture array 59 which are inserted between the first and second imaging optical systems as shown in FIG. 9.

The micro-lens array 55 is constituted so that plural micro-lenses 55a corresponding to the respective pixels of the DMD 50 are arranged two-dimensionally. In the exemplary embodiment, as described below, since only 1024 pieces×256 rows micro-mirrors among 1024 pieces×768 rows micro-mirrors of the DMD 50 are driven, accordingly the micro-lenses 55a are arranged into 1024 pieces×256 rows. An arrangement pitch of the micro-lenses 55a is 41 μm in both vertical and horizontal directions. The micro-lens 55a has a focusing length of 0.19 mm and NA (numerical aperture) of 0.11 and is formed by optical glass BK7, for example. A beam diameter of the laser light B in the positions of the respective micro-lenses 55a is 41 μm. The aperture array 59 is constituted so that plural apertures 59a corresponding to the respective micro-lenses 55a of the micro-lens array 55 are formed. In this exemplary embodiment, the diameter of the aperture 59a is 10 μm.

The first imaging optical system enlarges an image from the DMD 50 into three times as large as the image so as to image the enlarged image on the micro-lens array 55. The second imaging optical system enlarges the image through the micro-lens array 55 into 1.6 times as large as the latter image so as to image and project it onto the recording medium 150. Therefore, the image from the DMD 50 is totally enlarged to 4.8 times as large as the image so as to be imaged and projected onto the recording medium 150. In this exemplary embodiment, a prism pair 73 is disposed between the second imaging optical system and the recording medium 150, and the prism pair 73 is moved vertically in FIG. 9, so that a focus of the image on the recording medium 150 may be adjusted. The recording medium 150 is carried in the direction of the arrow F (sub scanning direction) in FIG. 9.

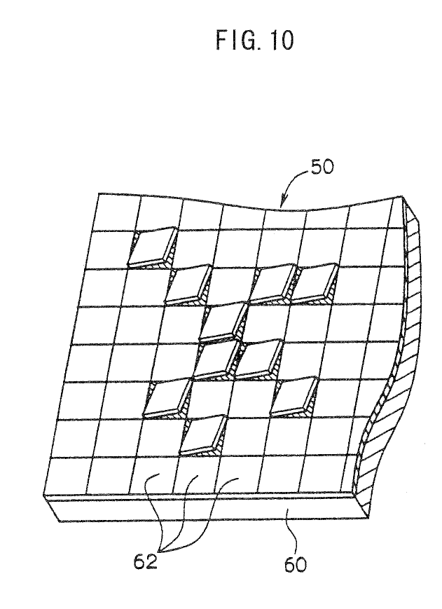

As shown in FIG. 10, the DMD 50 is a mirror device, which is constituted so that plural (for example, 1024×768) micro-mirrors 62 composing the respective pixels are arranged into a lattice pattern on an SRAM cell (memory cell) 60. In each pixel, the micro-mirror 62 supported by a support rod is provided at a top portion, and a material having high reflectance such as aluminum is deposited on the surfaces of the micro-mirrors 62. The reflectance of the micro-mirrors 62 is 90% or more, and the arrangement pitch therebetween is, for example, 13.7 μm in both vertical and horizontal directions. The SRAM cell 60 of CMOS of a silicon gate manufactured by a normal semiconductor memory manufacturing line is arranged just below the micro-mirrors 62 via the support rod including a hinge and a yoke, and is monolithically constituted as a whole.

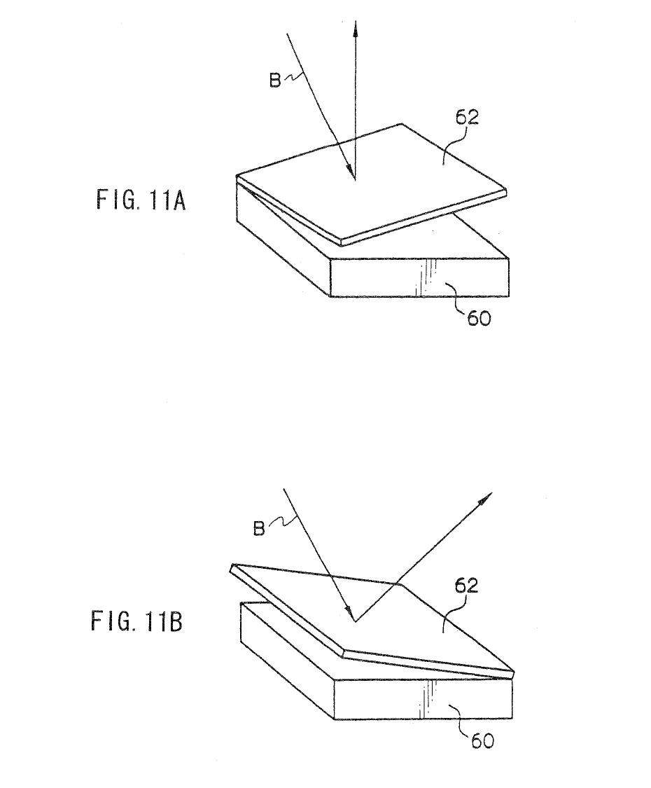

When a digital signal is written into the SRAM cell 60 of the DMD 50, the micro-mirror 62 supported by the support rod is inclined around a diagonal line with respect to the board side where the DMD 50 is arranged within a range of ±α° (for example, ±12°). FIG. 11A illustrates the state where the micro-mirror 62 is inclined by +α° which is an ON state, and FIG. 11B illustrates the state where the micro-mirror 62 is inclined by −α° which is an OFF state. Therefore, the inclining of the micro-mirror 62 in each pixel of the DMD 50 is controlled according to an image signal as shown in FIG. 10, whereby the laser light B incident on the DMD 50 is reflected toward the inclining directions of the micro-mirrors 62. FIG. 10 illustrates one example of the state where the DMD 50 is partially enlarged, and the micro-mirrors 62 are controlled so as to have +α° or −α°. The respective on/off control to the micro-mirrors 62 is performed by the controller 302 connected to the DMD 50. Light absorbers (not shown) are arranged in the emitting direction of the laser light B reflected by the micro-mirrors 62 in the off state.

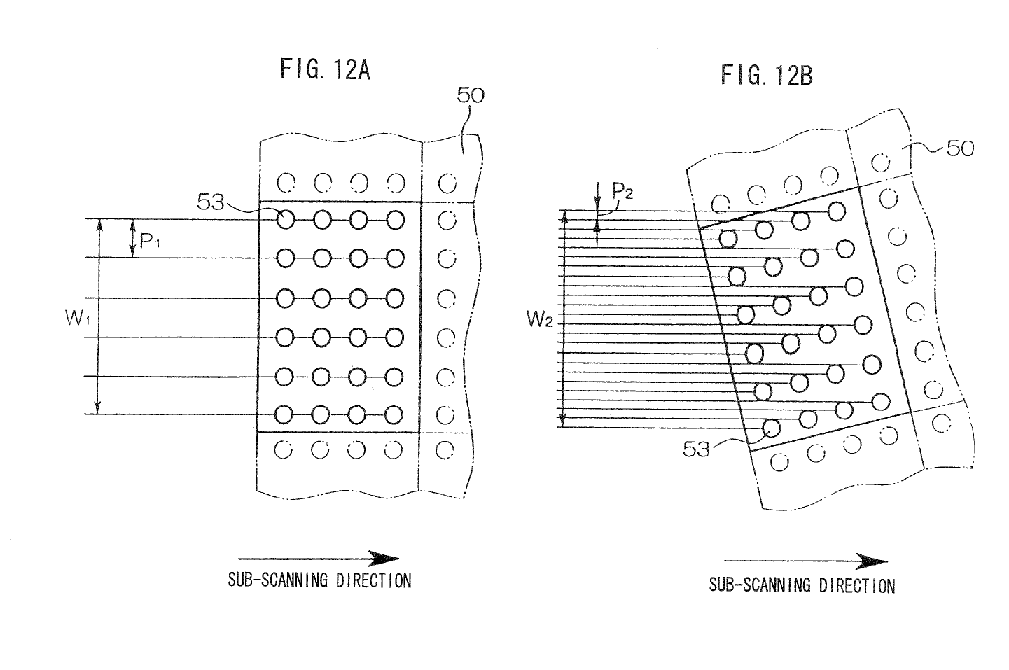

The DMD 50 is preferably inclined slightly so that a predetermined angle θ (for example, 0.1° to 5°) is obtained between its short side and the sub scanning direction. FIG. 12A illustrates scanning trajectories of reflected light images (exposing beams) 53 by means of the respective micro-mirrors when the DMD 50 is not inclined, and FIG. 12B illustrates scanning trajectories of the exposing beams 53 when the DMD 50 is inclined. Plural sets (for example, 768 sets) of micro-mirror rows, where plural (for example, 1024) micro-mirrors are arranged in the longitudinal direction, are arranged in the widthwise direction on the DMD 50. When the DMD 50 is inclined as shown in FIG. 12B, a pitch P₂ of the scanning trajectories (scanning lines) of the exposing beams 53 by means of the micro-mirrors becomes narrower than a pitch P₁ of the scanning lines when the DMD 50 is not inclined, therefore the resolution can be improved greatly. On the other hand, since the inclining angle of the DMD 50 is very small, a scanning width W₂ in the case where the DMD 50 is inclined is approximately the same as a scanning width W₁ in the case where the DMD 50 is not inclined.

When the DMD 50 is inclined, the same scanning lines are overlappingly exposed (multiple exposure) by different micro-mirror rows. The exposing position with respect to an alignment mark can be controlled slightly due to such multiple exposure, thereby realizing high definite exposure. Joints between the plurality of exposing heads arranged in the horizontal scanning direction may be obtained without unevenness by slight control of the exposing positions. The same effect can be obtained by arranging the respective micro-mirrors rows zigzag instead of the inclining of the DMD 50.

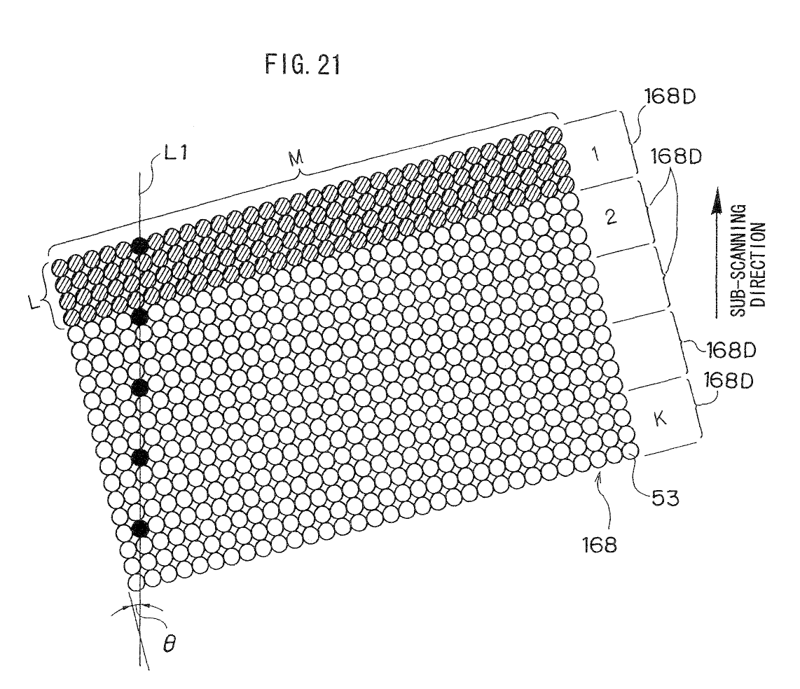

In the exemplary embodiment, as shown in FIG. 21, the DMD 50 is arranged in a inclining manner so that the exposed area 168 inclines with respect to the sub scanning direction only by the inclining angle θ=±tan⁻¹ (n/L). In FIG. 21, the exposed area 168 obtained by single DMD 50 is divided into K-numbered regions (divided regions 168D) for respective regions in L lines×M rows along the sub scanning direction, and n and L are relatively prime natural numbers or n is a number equal to L. In FIG. 21, n=1, and a clockwise direction viewed from a scanning line L1 is a + direction of the inclining direction. As one example, in FIG. 21, L=4, M=32 and K=5, however, actually the single exposed area 168 is composed of more exposing beams 53.

When the exposed areas 168 are inclined, the pitch of the scanning trajectories (scanning lines) of the exposing beams 53 by means of the micro-mirrors becomes narrower than that in the case where the exposed areas 168 are not inclined, whereby the resolution can be improved. Since the inclining angle θ of the exposed areas 168 with respect to the sub scanning direction is ±tan⁻¹ (n/L), the respective scanning lines are scanned by the reflected light images (exposing beams) 53 in the respective divided regions 168D so as to be multiply-exposed (K times) by the exposing beams 53 reflected by the different micro-mirrors 62 in the DMD 50. For example, when an attention is paid to the scanning line L1 shown in FIG. 21, the scanning line L1 is scanned by the individual exposing beams 53 (see the exposing beams 53 shown by “” in FIG. 21) of the respective divided regions 168D, and thus is exposed five times accordingly. In this manner, an image with uniform density where variation of the image density is eliminated can be obtained by the multiple exposure.

That is, the quality of light occasionally varies slightly in the individual exposing beams 53 (corresponding to partial laser light fluxes described in the fifth aspect) composing the exposed area 168, and the distribution wavelength range is not uniform. For this reason, when each scanning line is scanned only by a single exposing beam 53, the variation of the quantity of light of the exposing beams 53 and the non-uniformity of the distribution wavelength range (a fluctuation of the light transmittance through the light-transmitting layer 110 due thereto) appear as a variation of the image density on the corresponding scanning lines, and thus the density varies in the image to be exposed and recorded on the recording medium 150. By contrary, in the exemplary embodiment, since a multiple exposure, wherein each scanning line is scanned by the plurality of exposing beams 53, is performed, the exposing amount of the exposing beams 53 to the respective portions on the recording medium 150 (an integrated value of the quantity of the irradiated light of the exposing beams 53) can be uniformized, and the density of the image to be exposed and recorded on the recording medium 150 can be uniformized.

Further, the DMD 50 corresponds to a surface modulation element described in the fifth aspect, a surface of the DMD 50 where the micro-mirrors 62 are provided (the surface on which laser light is incident) corresponds to a modulation surface described in the fifth aspect, and regions of the laser light incident surface where the micro-mirrors 62 are provided correspond to the modulation regions described in the fifth aspect.

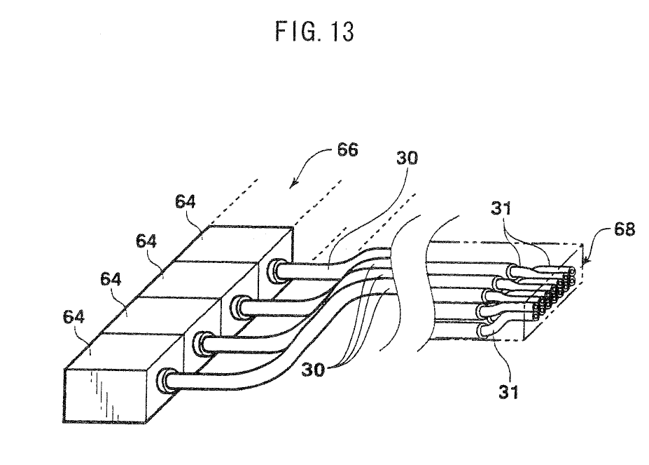

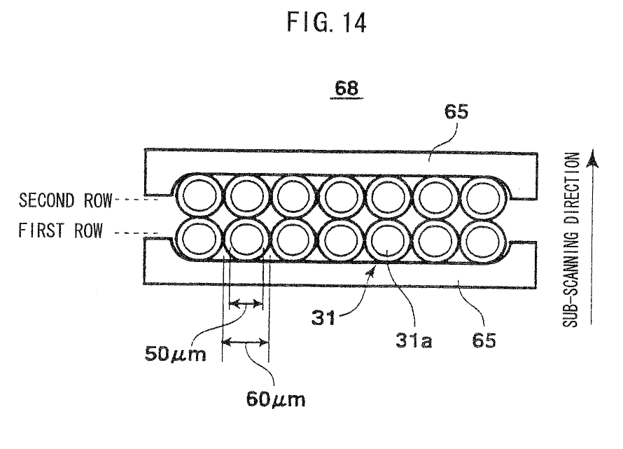

As shown in FIG. 13, the fiber array light source 66 has a plurality (for example, 14) of laser modules 64, and the respective laser modules 64 are respectively jointed to one ends of the multimode optical fibers 30. The other ends of the multimode optical fibers 30 are jointed to optical fibers 31 whose core diameters are the same as those of the multimode optical fibers 30 and whose clad diameters are smaller than those of the multimode optical fibers 30. As shown more specifically in FIG. 14, seven end portions of the multimode optical fibers 31 opposite to the optical fibers 30 are arranged along the main scanning direction perpendicular to the sub scanning direction, and two lines of the end portions are arranged so as to construct a laser emitting portion 68. The laser emitting portion 68 constructed by the end portions of the multimode optical fibers 31 is sandwiched between two supporting plates with flat surfaces so as to be fixed as shown in FIG. 14. A transparent protective plate for protecting such as glass or the like is desirably disposed at the light emitting end surface of the multimode optical fibers 31. The light emitting end surface of the multimode optical fibers 31 which have high light density easily collects dust and is thus easily deteriorated, however, when the above-described protective plate is arranged, adhesion of dust to the end surface can be prevented and the deterioration can be slowed.

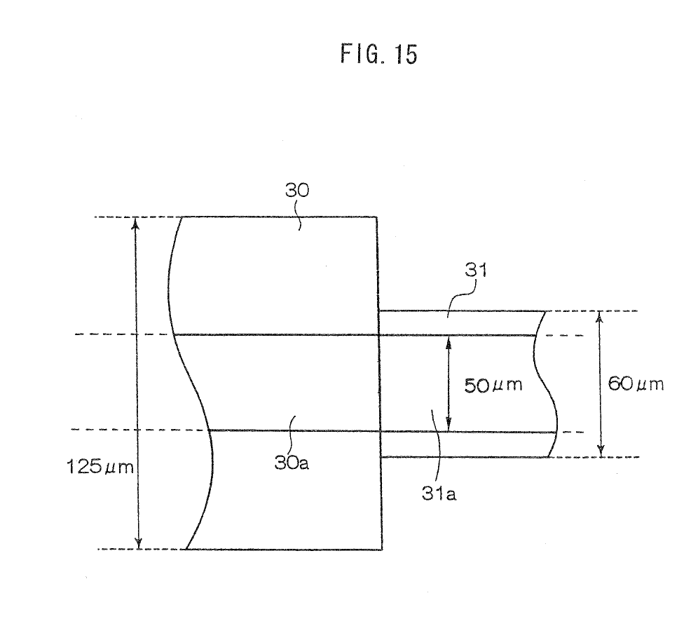

As shown in FIG. 15, in the exemplary embodiment, the optical fibers 31 which have a length of about 1 to 30 cm and a small clad diameter are jointed to leading end portions at the laser light emitting sides of the multimode optical fibers 30 having a large clad diameter by fusion-bonding the incident end surfaces of the optical fibers 31 to the emitting end surfaces of the optical fibers 30 with respective core axes of the optical fibers 31 matching with those of the optical fibers 30. Any one of a step index type optical fiber, graded index type optical fiber and a complex type optical fiber may be applied to the multimode optical fiber 30 and the optical fiber 31. For example, a step index type optical fiber manufactured by MITSUBISHI CABLE INDUSTRIES, LTD. can be used. In the exemplary embodiment, the multimode optical fiber 30 and the optical fiber 31 are the step index type optical fibers, the multimode optical fiber 30 has a clad diameter of 125 μm, a core diameter of 50 μm, NA of 0.2 and transmittance through the incident end surface coat of 99.5% or more, and the optical fiber 31 has a clad diameter of 60 μm, a core diameter of 50 μm and NA of 0.2.

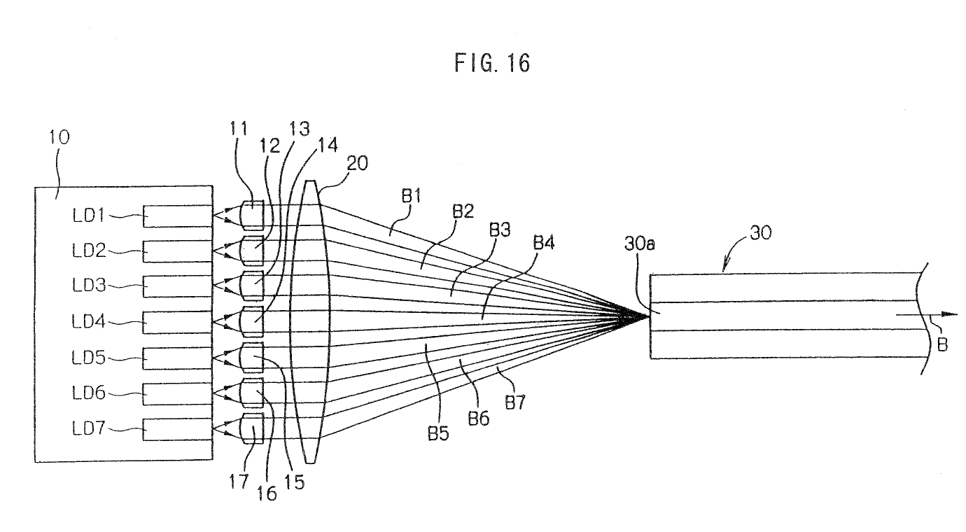

The laser module 64 is constructed by combined laser light source (fiber light source) shown in FIG. 16. The combined laser light source is constructed by a plurality (for example, 7) of chip-shaped GaN semiconductor lasers LD1, LD2, LD3, LD4, LD5, LD6 and LD7 of a lateral multimode or a single mode which are arranged and fixed onto a heat block 10, collimating lenses 11, 12, 13, 14, 15, 16 and 17 which are provided corresponding to the respective semiconductor lasers LD1 to LD7, a single condensing lens 20, and one multimode optical fiber 30. The number of the semiconductor lasers LD is not limited to seven, and another number of the semiconductor lasers may be used. Instead of the seven collimating lenses 11 to 17, a collimating lens array in which these lenses are integrated can be used. The maximum output is common among the semiconductor lasers LD1 to LD7 (for example, about 100 mW in the multimode laser, and about 50 mW in the single mode laser). An oscillation wavelength of the semiconductor laser LD is determined as follows.

That is, since the plurality of laser modules 64 are provided in a single exposing head 166 and the plurality of semiconductor lasers LD are provided in each laser module 64, multiple semiconductor lasers LD as the laser light sources are provided in the single exposing head 166 (when the number of the laser modules 64 provided in the single exposing head 166 is 14 and the number of the semiconductor lasers LD provided in each laser module 64 is 7, the total number of the semiconductor lasers LD provided in the single exposing head 166 is 98). However, in the exemplary embodiment, the oscillation wavelength of all the semiconductor lasers LD provided in the single exposing head 166 is determined so as to be distributed approximately uniformly within a wavelength range of 400 to 410 nm (405±5 nm).

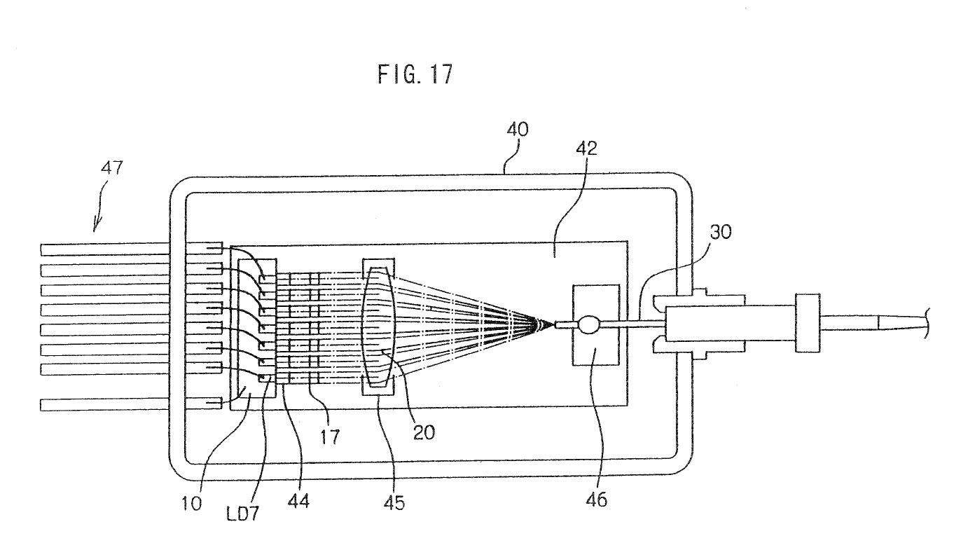

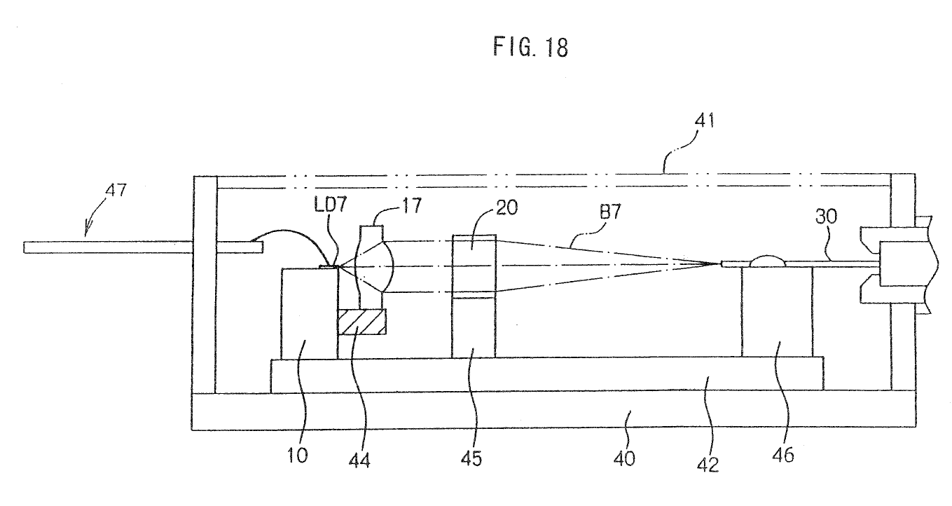

The above-described combined laser light source, as well as other optical elements, is housed in a box-shaped package 40 whose upper portion is opened as shown in FIGS. 17 and 18. The package 40 has a package cover 41 which is constituted to close the opening, and the combined laser light source is sealed airtightly into a closed space (sealed space) which is formed by introducing sealing gas after a degassing process and closing the opening of the package 40 by the package cover 41. A base plate 42 is fixed to a bottom surface of the package 40, and the heat block 10, a condensing lens holder 45 for holding the condensing lens 20, and a fiber holder 46 for holding the incident end portion of the multimode optical fibers 30 are mounted to an upper surface of the base plate 42. The emitting end portion of the multimode optical fibers 30 is drawn out of the package through an opening formed in a wall surface of the package 40.

Collimating lens holders 44 are mounted at a side surface of the heat block 10, and the collimating lenses 11 to 17 are held in the collimating lens holders 44. An opening is formed in a lateral wall surface of the package 40, and the wirings 47 which supply driving current to the semiconductor lasers LD1 to LD7 are pulled out of the package through the opening. In FIG. 18, in order to avoid the intricate drawing, only the reference number of the semiconductor laser LD7 among the plurality of semiconductor lasers is illustrated, and only the reference number of the collimating lens 17 among the plurality of collimating lenses is illustrated.

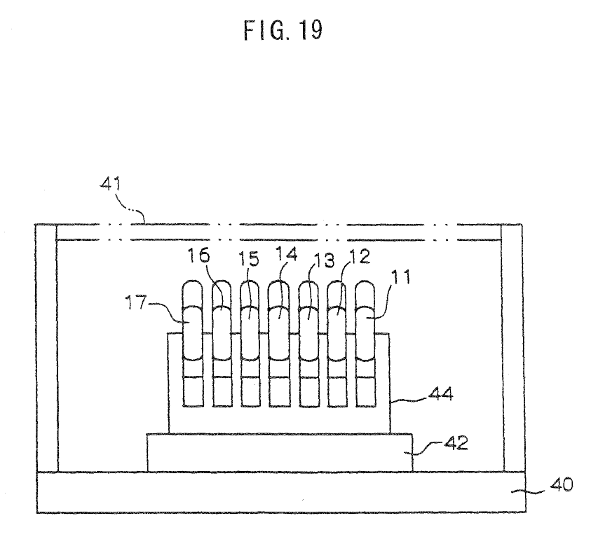

As shown in FIG. 19, the collimating lenses 11 to 17 are formed into a shape wherein a region including an optical axis of a circular lens having an aspheric surface is cut out into an elongated shape by parallel planes. The elongated collimating lenses can be formed by molding resin or optical glass. The collimating lenses 11 to 17 are arranged closely in an arrangement direction of the light emitting points of the semiconductor lasers LD1 to LD7 so that their longitudinal directions are perpendicular to the arrangement direction (left-right direction of FIG. 19) of the light emitting points. On the other hand, as the semiconductor lasers LD1 to LD7, lasers, which have an active layer with light-emitting width of 2 μm and emit laser light B1 to B7 whose divergence angles in parallel and vertical directions with respect to the active layer are 10° and 30°, are used. These semiconductor lasers LD1 to LD7 are arranged so that the light emitting points are arranged in one line in a direction parallel to the active layer.

Therefore, the laser light 31 to B7 emitted from the respective light-emitting points are incident to the elongated collimating lenses 11 to 17 with a direction where the divergence angles are large being matched with the longitudinal directions of the collimating lenses 11 to 17 and the direction where the divergence angles are small being matched with the widthwise direction (a direction perpendicular to the longitudinal direction). The condensing lens 20 has a flat shape wherein a region including the optical axis of a circular lens having an aspheric surface is cut out into an elongated shape by parallel planes, and is arranged so that the longitudinal direction of the flat shape is along the arrangement direction of the collimating lenses 11 to 17, namely, the horizontal direction. The laser light B1 to B7 transmitting through the collimating lenses 11 to 17 is condensed by the condensing lens 20 so as to be respectively incident to the incident end portions of the multimode optical fibers 30.

As shown in FIG. 20, the image exposing device 100 has a general control portion 300 which controls the operation of the overall image exposing device 100, and the general control portion 300 is connected to a modulation circuit 301, and the modulation circuit 301 is connected to the controller 302 which controls the DMD 50. an LD driving circuit 303 which drives the laser modules 64, and the stage driving device 304 which drives the moving stage 152 are respectively connected to the general control portion 300.

[The Operation of the Image Exposing Device]

The operation of the image exposing device 100 is described as the function of the exemplary embodiment. When an image such as a wiring pattern is to be exposed and recorded on the recording medium 150, the general control portion 300 causes the semiconductor lasers LD1 to LD7 provided to the respective laser modules 64 of the respective exposing heads 166 in the scanner 162 to emit light via the LD driving circuit 303. In this manner, the laser light B1, B2, B3, B4, B5, B6 and B7 is respectively emitted from the semiconductor lasers LD1 to LD7 as divergent light, and the laser light B1 to B7 is collimated by the corresponding collimating lenses 11 to 17. The collimated laser light B1 to B7 is condensed by the condensing lens 20, so as to converge at the incident end surface of the core 30a of the multimode optical fiber 30.

In the exemplary embodiment, the collimating lenses 11 to 17 and the condensing lens 20 construct a condensing optical system, and the condensing optical system and the multimode optical fibers 30 construct the combined optical system. The laser light B1 to B7 condensed by the condensing lens 20 is incident into the core 30a of the multimode optical fiber 30 so as to transmit in the optical fiber, and is combined into one laser light B so as to be emitted from the optical fiber 31 jointed to the emitting end portion of the multimode optical fiber 30. In each of the laser modules 64, for example, when combining efficiency of the laser light B1 to B7 to the multimode optical fiber 30 is 0.9 and the respective outputs form the semiconductor lasers LD1 to LD7 are 50 mW, a combined laser light B with an output of 315 mW 50 mW×0.9×7) can be obtained from each of the laser modules 64 (each of the optical fibers 31 arranged into an array pattern). Therefore, the laser light B with an output of 4.4 W (=0.315 W×14) can be obtained from all the 14 multimode optical fibers 31.

When an image such as a wiring pattern is to be exposed and recorded on the recording medium 150, image data (drawing raster data) representing the image to be exposed and recorded is input from the modulation circuit 301 into the controller 302, and is once stored in a frame memory contained in the controller 302. The image data is data in which the density of respective pixels composing the image is represented by binary (presence/absence of dot recording). When the image is exposed and recorded on the recording medium 150, the moving stage 152 which adsorbs the recording medium 150 on the surface thereof is moved at a constant speed from an upstream side to a downstream side of the gate 160 along the guides 158 by the stage driving device 304.

When the moving stage 152 is passing below the gate 160 and the sensors 164 mounted to the gate 160 detect a leading end of the recording medium 150, the image data stored in the frame memory of the controller 302 is sequentially read out by a plurality of lines by the data processing portion of the controller 302, and a control signal is generated for each of the exposing heads 166 based on the read out image data. The mirror driving control portion of the controller 302 controls the micro-mirrors of the DMD 50 in each of the exposing heads 166 based on the control signal generated by the data processing portion so that the micro-mirrors are switched into the ON state or the OFF state.

In each of the exposing heads 166, when the laser light B is irradiated to the DMD 50 from the fiber array light source 66, the laser light reflected by the micro-mirrors in the ON state among the micro-mirrors in the DMD 50 transmits through the lens systems 54 and 58 so as to be imaged on the recording medium 150. resulting this manner, the laser light emitted from the fiber array light source 66 is modulated into ON or OFF state in each pixel, and the recording medium 150 is exposed in the pixel units (exposed areas 168) whose number is approximately the same as the number of the used pixels (the number of the micro-mirrors whose on/off state are controlled) in the DMD 50. When the recording medium 150 is moved together with the moving stage 152 at the constant speed, the sub scanning is carried out in such a manner that the recording medium 150 moves to a direction opposite to the stage moving direction with respect to the scanner 162, the band-shaped exposed regions 170 corresponding to the respective exposing heads 166 are formed on the recording medium 150, and the image is exposed and recorded on the recording medium 150.

The image is exposed and recorded on the recording medium 150 in such a manner that the laser light irradiated to the recording medium 150 transmits through the light-transmitting layer 110 of the resist film 106 and reach the photosensitive layer 108. However, since the thickness of the light-transmitting layer 110 of the resist film 106 at the respective portions of the recording medium 150 varies within a manufacturing tolerance range, the resonance frequency of the light-transmitting layer 110 also varies at the respective portions of the recording medium 150. When the laser light irradiated to the recording medium 150 is laser light with single wavelength, the quantity of light of the laser light transmitting through the light-transmitting layer 110 and reaching the photosensitive layer 108 (quantity of light transmitting through the light-transmitting layer) varies at the respective portions of the recording medium 150. The variation of the quantity of light transmitting through the light-transmitting layer appear as an apparent variation of sensitivity of the photosensitive layer 108 at the respective portions of the recording medium 150, and accordingly, the width of the lines in the wiring pattern exposed and recorded on the recording medium 150 varies at the respective portions of the recording medium 150. Particularly, since the recording medium 150 has the light-transmitting layer 110 with glazing, the phenomena that the amplitude of the laser light transmitting through the light-transmitting layer 110 becomes large and the resonance frequency of the light-transmitting layer 110 varies at the respective portions of the recording medium 150 appear notably as the variation of the quantity of light transmitting through the light-transmitting layer at the respective portions of the recording medium 150.

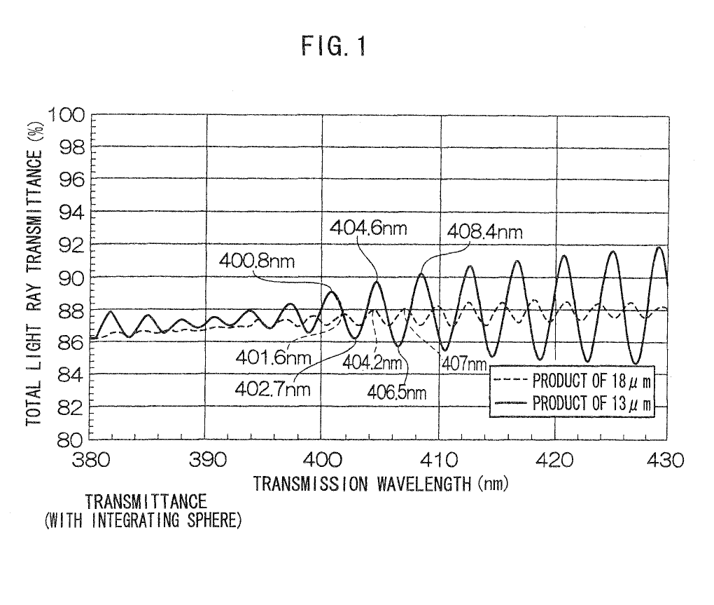

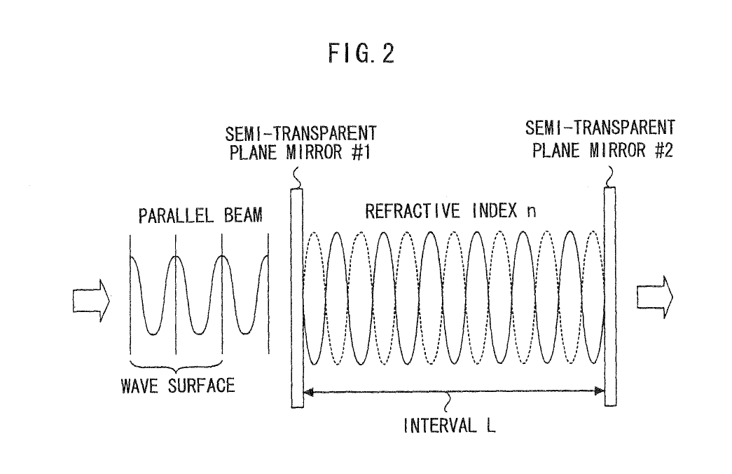

By contrary, in the image exposing device 100 according to the exemplary embodiment, as described above, plural semiconductor lasers LD are provided as the laser light sources in a single exposing head 166, and the oscillation wavelength of all the semiconductor lasers LD provided in the single exposing head 166 is determined so as to be distributed uniformly within the wavelength range of 400 to 410 nm (405±5 nm). As is clear from FIG. 1, the wavelength range of 400 to 410 nm is wider than the resonance minimum wavelength range of the light-transmitting layer 110 (PET film) with nominal film thickness of 13 μm (actual film thickness is 13.15 μm) (more specifically, four or more times as large as the resonance minimum wavelength range), and is wider than the resonance minimum wavelength range of the light-transmitting layer 110 (PET film) with nominal film thickness of 18 μm (actual film thickness is 18.6 μm) (more specifically, four or more times as large as the resonance minimum wavelength range).

After the laser light emitted from the plurality of semiconductor lasers LD provided in the single exposing head 166 are condensed and combined to the identical multimode optical fiber 30 in the unit of the plural semiconductor lasers LD provided in the identical laser module 64, all the laser light is combined by the lens system 67, whereby the intensity in the beam cross-portion, wherein the beams are close to parallel light, is uniformized, the laser light obtained by combining the laser light with respective wavelengths within the wavelength range is irradiated to the DMD 50, and is irradiated as exposing laser light to the regions corresponding to the exposing heads 166 in the recording medium 150 after being modulated by the DMD 50.

In this manner, at the portion where the quantity of light transmitting through the light-transmitting layer with a specified wavelength included in the exposing laser light indicates a minimum value among the respective portions on the recording medium 150, the quantity of light transmitting through the light-transmitting layer of the laser light with other wavelengths included in the exposing laser light indicates a value larger than the minimum value, whereby a reduction in the quantity of light transmitting through the light-transmitting layer of the entire exposing laser light at the portion is repressed. At the same time, at the portion where the quantity of light transmitting through the light-transmitting layer with a specified wavelength included in the exposing laser light indicates a maximum value among the respective portions on the recording medium 150, the quantity of light transmitting through the light-transmitting layer of the laser light with other wavelengths included in the exposing laser light indicates a value smaller than the maximum value, whereby an increase in the quantity of light transmitting through the light-transmitting layer of the entire exposing laser light at the portion is repressed. Therefore, the variation of the quantity of light transmitting through the light-transmitting layer of the entire exposing laser light at the respective portions of the recording medium 150 can be reduced, and the apparent sensitivity unevenness of the photosensitive layer 108 at the respective portions of the recording medium 150 can be repressed, while the variation of the width of the respective lines in the wiring pattern exposed and recorded on the recording medium 150 at the respective portions of the recording medium 150 can be repressed.

Also when the wavelength of the laser light to be emitted from the respective semiconductor lasers LD of the exposing head 166 changes due to the fluctuation of the internal temperature of the exposing head 166 (ambient temperature of the semiconductor lasers LD), the laser light whose quantity of light transmitting through the light-transmitting layer reduces further than that before the change of the wavelength is generated in the exposing laser light, whereas the laser light whose quantity of light transmitting through the light-transmitting layer increases further than that before the change of the wavelength is generated at the respective portions of the recording medium 150. Therefore, the fluctuation of the quantity of light transmitting through the light-transmitting layer of the overall exposing laser light at the respective portions of the recording medium 150 is repressed, and the fluctuation of the wavelength of the laser light is also repressed. In this manner, the apparent change of the sensitivity of the photosensitive layer 108 at the respective portions of the recording medium 150 can be repressed, and the change of the width of the lines in the wiring pattern exposed and recorded on the recording medium 150 can be repressed. Therefore, the variation of the thickness of the light-transmitting layer 110 at the respective portions of the recording medium 150 and the fluctuation of the wavelength of the laser light due to the fluctuation of ambient temperature of the semiconductor lasers LD can be prevented from exerting adverse effects on the image quality of an image to be exposed and recorded on the recording medium 150, and the image can be exposed and recorded on the recording medium 150 with high quality and high definition.

The above description refers to the example wherein the oscillation wavelength of all the semiconductor lasers LD provided in the single exposing head 166 is determined so as to be distributed approximately uniformly within the wavelength range of 400 to 410 nm (405±5 nm), and thus the oscillation wavelength of the semiconductor lasers LD wherein the emitted laser light is to be combined and irradiated to the recording medium 150 is distributed approximately uniformly within the wavelength range which is four or more times as large as the resonance minimum wavelength range of the light-transmitting layer 110 of the recording medium 150 (more specifically, the PET film having nominal film thickness of 13 μm or 18 μm (actual film thickness is 13.15 μm or 18.6 μm)). However, the invention is not limited to this, and thus the oscillation wavelength of the semiconductor lasers LD wherein the emitted laser light is to be combined and irradiated to the recording medium 150 may be distributed within the wavelength range which is two or more times as large as the resonance minimum wavelength range of the light-transmitting layer 110 of the recording medium 150 or may be distributed within the wavelength range greater than or equal to the resonance minimum wavelength range of the light-transmitting layer 110 of the recording medium 150. Also in this case, the effect for repressing the image degradation due to the sensitivity unevenness and the change of sensitivity of the recording medium can be obtained.

The above description refers to the example wherein the oscillation wavelength of the semiconductor lasers LD wherein the emitted laser light is to be combined and irradiated to the recording medium 150 is distributed approximately “uniformly” within the wavelength range greater than or equal to the resonance minimum wavelength range of the light-transmitting layer 110 of the recording medium 150, however, the invention is not limited to this. It is desired that the oscillation wavelength of the laser light sources is distributed approximately “uniformly” within the wavelength range, but even if the oscillation wavelength of the laser light sources is distributed simply within the wavelength range (even if the distribution of the oscillation wavelength within the wavelength range is slightly biased), the effect for repressing the image degradation due to the sensitivity unevenness and the change of sensitivity of the recording medium can be obtained by comparison with a case where the laser light with a single wavelength is irradiated to the recording medium.

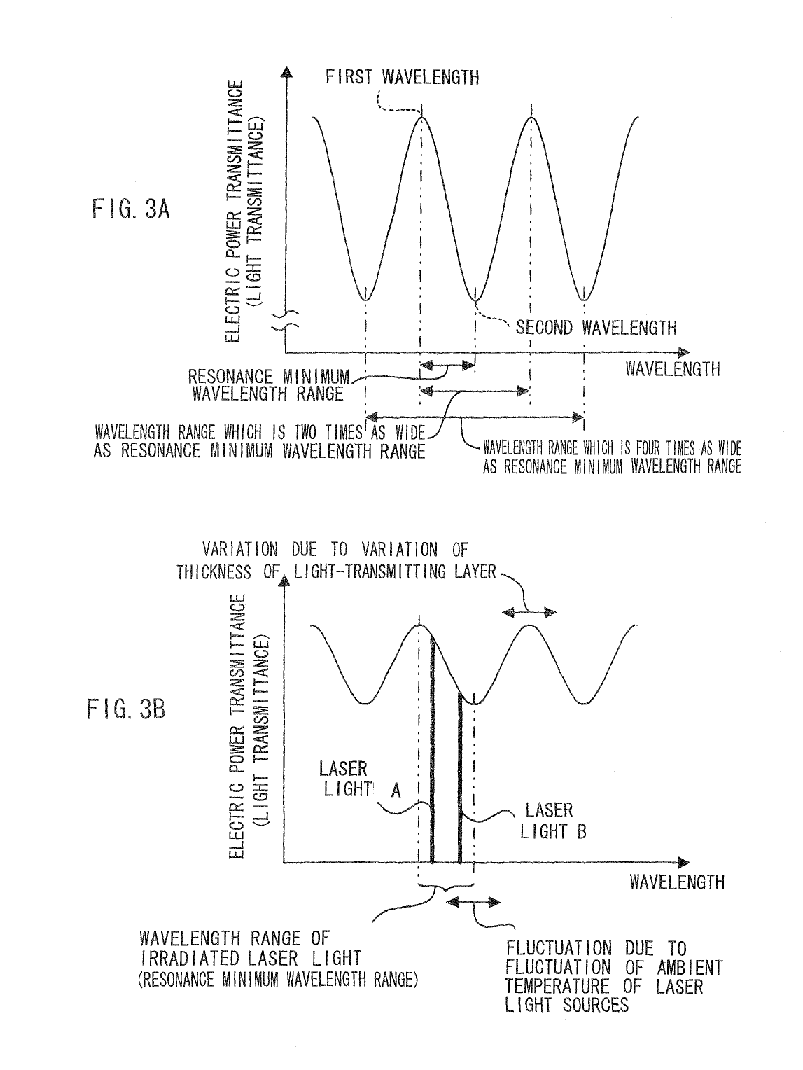

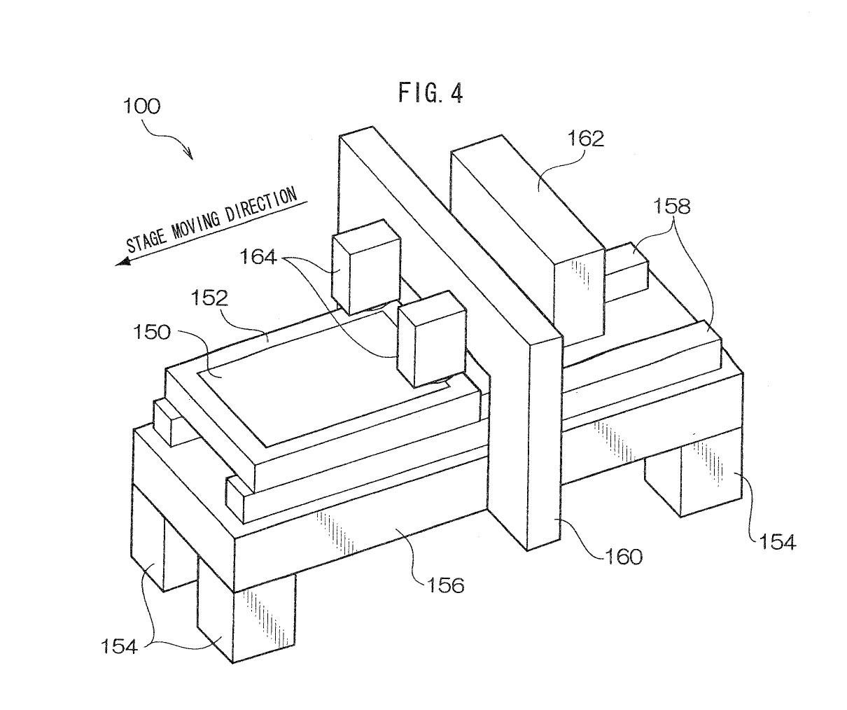

The above description refers to the example of the constitution where the laser light emitted from the plural semiconductor lasers LD is combined and irradiated to the recording medium 150 (when the number of the laser modules 64 provided in a single exposing head 166 is 14 and the number of the semiconductor lasers LD provided in the each laser modules 64 is 7, the total number of the semiconductor lasers LD provided in the single exposing head 166 (the total number of the semiconductor lasers wherein the emitted laser light is to be combined and irradiated to the recording medium 150) is 98). However, the number of laser light to be combined (the number of the semiconductor lasers LD) is not limited to the above numerical value and may be any plural numbers. As described with reference to FIG. 3 before, even if the number of the laser light sources whose emitted laser light is to be combined is two, as long as the wavelengths of the laser light emitted from the individual laser light sources are distributed within the resonance minimum wavelength range, the effect for repressing the image degradation due to the sensitivity unevenness and the change of sensitivity of the recording medium can be obtained by comparison with a case where the laser light with a single wavelength is irradiated to the recording medium.

Further, the above description refers to the example of the recording medium 150, as the recording medium of the present invention, wherein the resist film 106 having the light-transmitting layer 110 and only one photosensitive layer 108 is stuck to the board 104 which is formed with the conductive layer 104 made of copper being formed on the front and rear surfaces of the base material 104A made of glass epoxy. The invention is not, however, limited to this, and the invention may be applied to a recording medium which is constituted by sticking the resist film to a glass board. Such kind of recording medium is used when a color filter board to be used for a flat panel display or the like is manufactured. The above-described color filter board is manufactured in such a manner that a resist film is stuck to a glass board to form a recording medium, a filter pattern of a specified color among R, G and B is exposed and recorded on the recording medium, and the filter pattern of the specified color is formed on the glass board via a developing step or the like, and these operations are repeated as to the respective colors R, G and B. The resist film is also not limited to the constitution wherein only one photosensitive layer is provided as shown in FIG. 5, and thus the invention may be applied to a recording medium which is manufactured in such a manner that a resist film, which is formed by laminating a plurality of photosensitive layers and providing a light-transmitting layer at the laser light incident side, is used and the resist film is stuck to a board.

The above description refers to the example of the recording medium, as the recording medium of the present invention, which is manufactured by sticking the resist film provided with the light-transmitting layer and the photosensitive layer to the board or the like. The invention is not limited to this, and thus the invention may be applied to any recording medium which has a photosensitive layer and a light-transmitting layer on the photosensitive layer. It goes without saying that the image recording device of the invention is not limited to the constitution of the above-mentioned image exposing device 100, and thus the invention may be applied to an image recording device with any constitution for recording an image on any recording medium having a photosensitive layer and a light-transmitting layer thereon.

### Embodiment Example 1

A result of the analysis and study conducted by the inventors of this application in order to confirm the effect of the invention is described below. In this analysis and study, the level of a fluctuation of the light transmittance through the light-transmitting layer associated with the fluctuation of the wavelength range of the irradiated light is confirmed by calculating how the level of the fluctuation changes with the width of the wavelength distribution range of the irradiated light, based on a result of an experiment (see FIG. 1) wherein a change of the light transmittance through the light-transmitting layer with respect to a change of a wavelength of the irradiated light is determined with respect to the light-transmitting layer composed of a PET-made film with nominal film thickness of 13 μm. The result of the experiment is show by numerical values in Table 1.

TABLE 1
<Relationship between the wavelength of the irradiated
light and the light transmittance through the light-transmitting
layer of a product of 13 μm>

| Wavelength | Transmittance |
|---|---|
| (nm), | (%) |
| 400.0 | 88.12 |
| 400.2 | 88.52 |
| 400.4 | 88.80 |
| 400.6 | 88.96 |
| 400.8 | 89.09 |
| 401.0 | 89.01 |
| 401.2 | 88.83 |
| 401.4 | 88.50 |
| 401.6 | 87.97 |
| 401.8 | 87.48 |
| 402.0 | 86.98 |
| 402.2 | 86.56 |
| 402.4 | 86.31 |
| 402.6 | 86.19 |
| 402.8 | 86.26 |
| 403.0 | 86.49 |
| 403.2 | 86.77 |
| 403.4 | 87.26 |
| 403.6 | 87.83 |
| 403.8 | 88.39 |
| 404.0 | 88.96 |
| 404.2 | 89.38 |
| 404.4 | 89.61 |
| 404.6 | 89.66 |
| 404.8 | 89.55 |
| 405.0 | 89.21 |
| 405.2 | 88.66 |
| 405.4 | 88.03 |
| 405.6 | 87.39 |
| 405.8 | 86.76 |
| 406.0 | 86.30 |
| 406.2 | 85.98 |
| 406.4 | 85.77 |
| 406.6 | 85.83 |
| 406.8 | 86.10 |
| 407.0 | 86.64 |
| 407.2 | 87.30 |
| 407.4 | 87.98 |
| 407.6 | 88.69 |
| 407.8 | 89.24 |
| 408.0 | 89.73 |
| 408.2 | 90.08 |
| 408.4 | 90.19 |
| 408.6 | 90.14 |
| 408.8 | 89.81 |
| 409.0 | 89.34 |
| 409.2 | 88.76 |
| 409.4 | 88.08 |
| 409.6 | 87.42 |
| 409.8 | 86.75 |
| 410.0 | 86.15 |
| 410.2 | 85.69 |
| 410.4 | 85.45 |
| 410.6 | 85.50 |
| 410.8 | 85.77 |
| 411.0 | 86.20 |
| 411.2 | 86.84 |
| 411.4 | 87.62 |
| 411.6 | 88.42 |
| 411.8 | 89.18 |
| 412.0 | 89.84 |

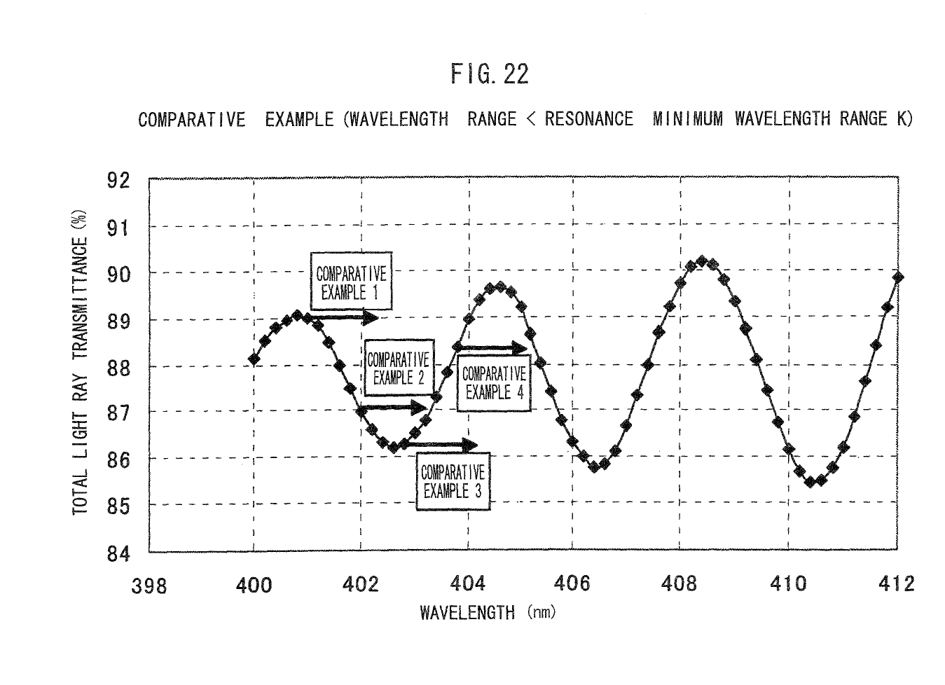

As comparative examples, the inventors of this application have calculated the average values of the light transmittance through the light-transmitting layer in a wavelength range of 401.0 to 402.2 (nm) set so that the width of the wavelength range is less than the resonance minimum wavelength range K (comparative example 1), in a wavelength range of 402.0 to 403.2 (nm) (comparative example 2), in a wavelength range of 402.8 to 404.2 (nm) (comparative example 3) and in a wavelength range of 403.8 to 405.2 (nm) (comparative example 4), calculated a difference between a maximum value and a minimum value of the average value of the light transmittance obtained for each wavelength range in the comparative examples 1 to 4 and a total average value, and further calculated “(maximum value−minimum value)/total average value” based on the result of the experiment. The wavelength ranges in the comparative examples 1 to 4 are shown by arrows in FIG. 22.

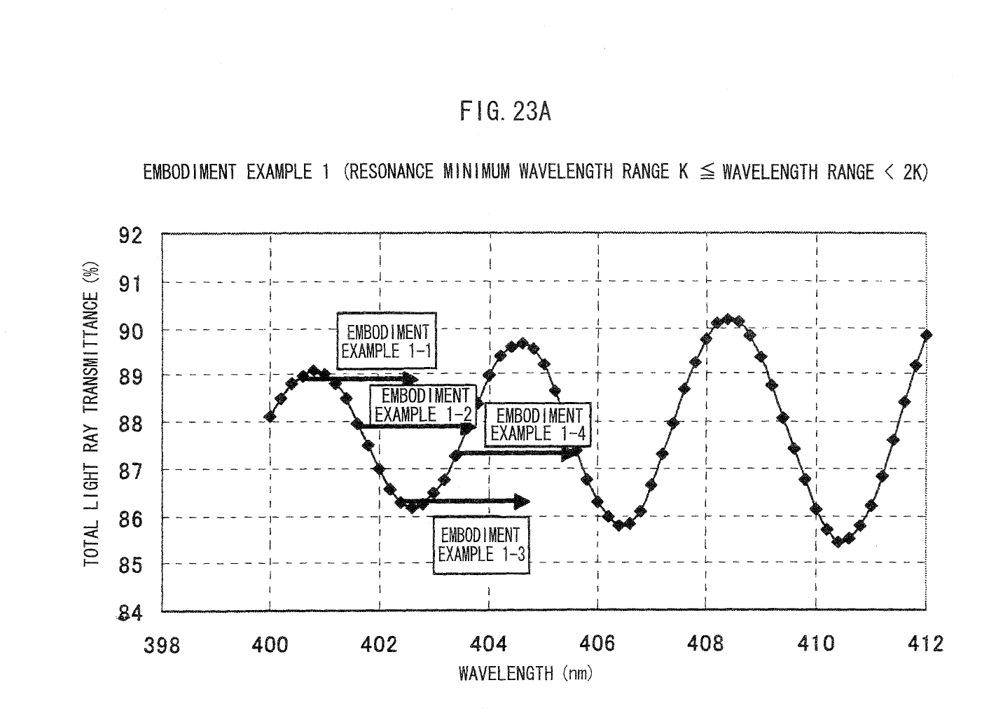

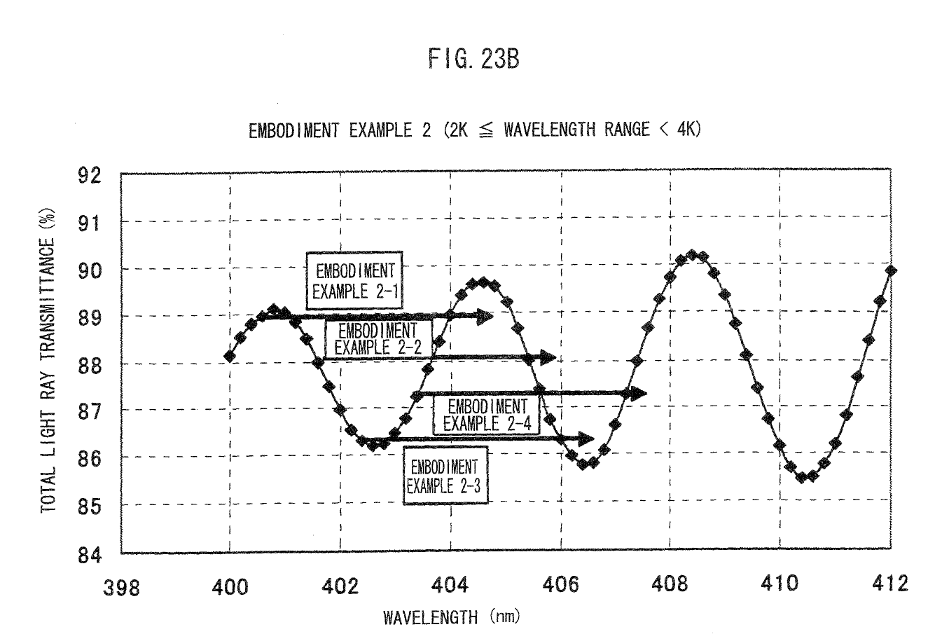

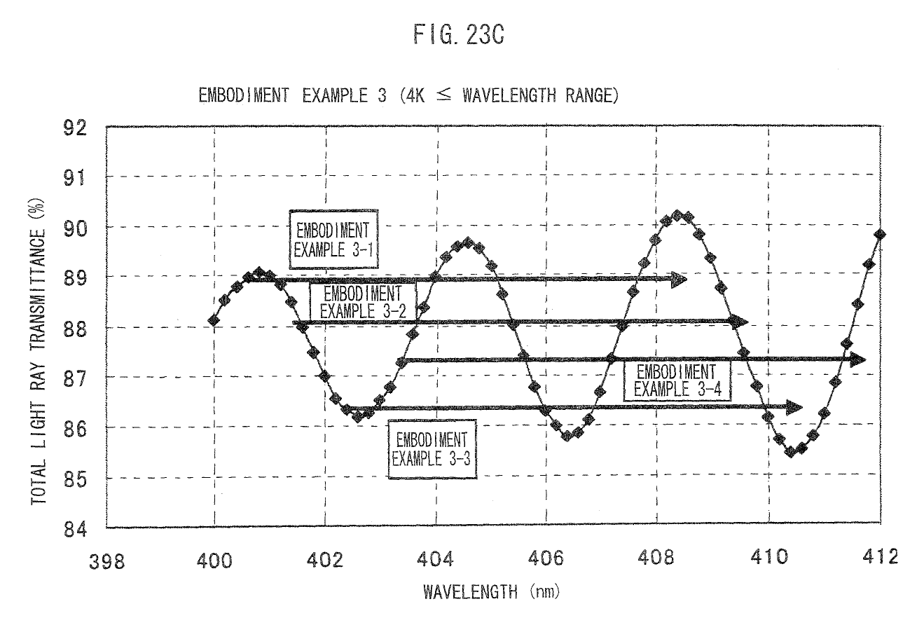

As embodiment example 1, the inventors of the application have calculated the average values of the light transmittance through the light-transmitting layer in a wavelength range of 400.6 to 402.8 (nm) set so that the width of the wavelength range is greater than or equal to the resonance minimum wavelength range and less than 2K (two times as large as the resonance minimum wavelength range K) (embodiment example 1-1), in a wavelength range of 401.6 to 403.8 (nm) (embodiment example 1-2), in a wavelength range of 402.4 to 404.8 (nm) (embodiment example 1-3) and in a wavelength range of 403.4 to 405.6 (nm) (embodiment example 1-4), calculated a difference between a maximum value and a minimum value of the average value of the light transmittance obtained for each wavelength range in the embodiment examples 1-1 to 1-4 and a total average value, and calculated “(maximum value−minimum value)/total average value”. The wavelength ranges in the embodiment examples 1-1 to 1-4 are shown by arrows in FIG. 23A.

As embodiment example 2, the inventors of the application have calculated the average values of the light transmittance through the light-transmitting layer in a wavelength range of 400.6 to 404.8 (nm) set so that the width of the wavelength range is greater than or equal to 2K (two times as large as the resonance minimum wavelength range K) and less than 4K (four times as large as the resonance minimum wavelength range K) (embodiment example 2-1), in a wavelength range of 401.6 to 405.6 (nm) (embodiment example 2-2), in a wavelength range of 402.4 to 406.6 (nm) (embodiment example 2-3) and in a wavelength range of 403.4 to 407.6 (nm) (embodiment example 2-4), calculated a difference between a maximum value and a minimum value of the average value of the light transmittance obtained for each wavelength range in the embodiment examples 2-1 to 2-4 and a total average value, and calculated “(maximum value−minimum value)/total average value”. The wavelength ranges in the embodiment examples 2-1 to 2-4 are shown by arrows in FIG. 23B.

Further, as embodiment example 3, the inventors of the application have calculated the average values of the light transmittance through the light-transmitting layer in a wavelength range of 400.6 to 408.6 (nm) set so that the width of the wavelength range is greater than or equal to 4K (four times as large as the resonance minimum wavelength range K) (embodiment example 3-1), in a wavelength range of 401.6 to 409.6 (nm) (embodiment example 3-2), in a wavelength range of 402.4 to 410.6 (nm) (embodiment example 3-3) and in a wavelength range of 403.4 to 411.6 (nm) (embodiment example 3-4), calculated a difference between a maximum value and a minimum value of the average value of the light transmittance obtained for each wavelength range in the embodiment examples 3-1 to 3-4 and a total average value, and calculated “(maximum value−minimum value)/total average value”. The wavelength ranges in the embodiment examples 3-1 to 3-4 are shown by arrows in FIG. 23C. The results of the above calculations are shown in Table 2.

TABLE 2
<Result of the Analysis and Study>

| | | Total light lay transmittance | | | |
|---|---|---|---|---|---|
| | | | | | (Maximum − |
| | | Average | | Total | minimum)/ |
| | Wavelength | value | Maximum − | average | total average |
| | range | (%) | minimum (%) | (%) | (%) |
| Comparative | Wavelength | 87.9 | 2.7 | 87. | 3.0 |
| example 1 | range < K | | | | |
| Comparative | Wavelength | 86.5 | | | |
| example 2 | range < K | | | | |
| Comparative | Wavelength | 87.7 | | | |
| example 3 | range < K | | | | |
| Comparative | Wavelength | 89.2 | | | |
| example 4 | range < K | | | | |
| Embodiment | K ≦ Wavelength | 87.7 | 1.6 | 87.8 | 1.8 |
| Example 1-1 | range < 2K | | | | |
| Embodiment | K ≦ Wavelength | 87 | | | |
| Example 1-2 | range < 2K | | | | |
| Embodiment | K ≦ Wavelength | 87.9 | | | |
| Example 1-3 | range < 2K | | | | |
| Embodiment | K ≦ Wavelength | 88.7 | | | |
| Example 1-4 | range < 2K | | | | |
| Embodiment | 2K ≦ Wavelength | 88 | 0.4 | 87.8 | 0.5 |
| Example 2-1 | range < 4K | | | | |
| Embodiment | 2K ≦ Wavelength | 87.9 | | | |
| Example 2-2 | range < 4K | | | | |
| Embodiment | 2K ≦ Wavelength | 87.6 | | | |
| Example 2-3 | range < 4K | | | | |
| Embodiment | 2K ≦ Wavelength | 87.8 | | | |
| Example 2-4 | range < 4K | | | | |
| Embodiment | 4K ≦ Wavelength | 88 | 0.2 | 88 | 0.3 |
| Example 3-1 | range | | | | |
| Embodiment | 4K ≦ Wavelength | 87.9 | | | |
| Example 3-2 | range | | | | |
| Embodiment | 4K ≦ Wavelength | 87.9 | | | |
| Example 3-3 | range | | | | |
| Embodiment | 4K ≦ Wavelength | 88.1 | | | |
| Example 3-4 | range | | | | |

The (maximum value−minimum value)/total average value obtained in the above analysis and study corresponds to a fluctuation ratio of the light transmittance through the light-transmitting layer when the wavelength range of the irradiated light to be irradiated to the light-transmitting layer shifts associated with the change of temperature. According to the results of the analysis and study by the inventors of the application, as shown in Table 2, as the wavelength range becomes wider from the comparative examples to Embodiment Example 3, the value of (maximum value−minimum value)/total average value) becomes clearly smaller. According to this result, it can be understood that, when the laser light emitted from the plurality of laser light sources is combined and the combined laser light is irradiated to the recording medium including the photosensitive layer and the light-transmitting layer provided over the photosensitive layer thereby recording an image on the recording medium, as long as the distribution range of the wavelength of the laser light emitted from the plurality of laser light sources is set at least greater than or equal to the resonance minimum wavelength range, preferably greater than or equal to two times as large as the resonance minimum wavelength range, more preferably greater than or equal to four times as large as the resonance minimum wavelength range, the fluctuation ratio of the light transmittance through the light-transmitting layer when the distribution range of the wavelength of the laser light emitted from the plurality of laser light sources shifts associated with the change of temperature or the like can be repressed small, and the fluctuation of the image quality of the recorded image can be repressed.

### DESCRIPTION OF REFERENCE NUMERALS

20: condensing lens
30, 31: optical fiber
50: DMD
71: condensing lens
72: rod integrator
100: image exposing device
104: board
106: resist film
108: photosensitive layer
110: light-transmitting layer
150: recording medium
166: exposing head
LD: semiconductor laser

1. An image recording device, wherein laser light emitted from a plurality of laser light sources is combined and the combined laser light is irradiated to a recording medium including a photosensitive layer and a light-transmitting layer provided over the photosensitive layer, so as to record an image on the recording medium, and
wherein the plurality of laser light sources are set such that respective wavelengths of the emitted laser light are distributed within a predetermined wavelength range greater than or equal to a resonance minimum wavelength range corresponding to a range between a first wavelength wherein light transmittance thereof through the light-transmitting layer is maximized and a second wavelength wherein the light transmittance thereof through the light-transmitting layer is minimized and the difference between the first and second wavelengths is minimized.

2. The image recording device of claim 1, wherein the predetermined wavelength range is two or more times as large as the resonance minimum wavelength range.

3. The image recording device of claim 1, wherein the predetermined wavelength range is four or more times as large as the resonance minimum wavelength range.

4. The image recording device of claim 1, wherein the plurality of laser light sources are set such that the wavelengths of the emitted laser light are distributed within the predetermined wavelength range and the respective light transmittances thereof through the light-transmitting layer vary.

5. The image recording device of claim 1, further comprising:
a surface modulation element wherein emitting directions of light fluxes incident on a modulation surface provided with a plurality of modulation regions are independently controllable in units of respective partial light fluxes incident on the respective modulation regions,
wherein laser light fluxes obtained by combining the laser light emitted from the plurality of laser light sources are caused to be incident on the modulation surface of the surface modulation element, and a plurality of partial laser light fluxes emitted in predetermined directions by the surface modulation element in the incident laser light fluxes are guided such that at least a part of the respective partial laser light fluxes emitted from the mutually different modulation regions of the surface modulation element are overlappingly irradiated to respective portions on the recording medium, whereby an image is recorded on the recording medium.

6. An image recording method for combining and irradiating laser light emitted from a plurality of laser light sources to a recording medium including a photosensitive layer and a light-transmitting layer provided over the photosensitive layer, so as to record an image on the recording medium, comprising:
determining respective wavelengths of the emitted laser light of the plurality of laser light sources so as to be distributed within a predetermined wavelength range greater than or equal to a resonance minimum wavelength range corresponding to a range between a first wavelength wherein light transmittance thereof through the light-transmitting layer is maximized and a second wavelength wherein the light transmittance thereof through the light-transmitting layer is minimized and the difference between the first and second wavelengths is minimized.
